(19) United States
(12) Patent Application Publication
(10) Pub. No.: US 2014/0379494 A1
(43) Pub. Date: Dec. 25, 2014

(54) AUCTION APPARATUS AND AUCTION METHOD

(71) Applicant: YAHOO JAPAN CORPORATION, Tokyo (JP)

(72) Inventors: Toru TAKATA, Tokyo (JP); Nobuyuki AKASHI, Tokyo (JP); Akira TAJIMA, Tokyo (JP); Koji TSUKAMOTO, Tokyo (JP); Nari WOO, Tokyo (JP); Akihiro TANABE, Tokyo (JP); Shinichiro SEGA, Tokyo (JP); Rin KATOU, Tokyo (JP)

(73) Assignee: YAHOO JAPAN CORPORATION, Tokyo (JP)

(21) Appl. No.: 14/021,410

(22) Filed: Sep. 9, 2013

(30) Foreign Application Priority Data
Jun. 20, 2013 (JP) 2013-129514

(51) Int. Cl. G06Q 30/02

(52) U.S. Cl. CPC G06Q 30/0275
USPC 705/14.71

(57) ABSTRACT

An auction apparatus according to the application includes a communication unit and an auction providing unit. The communication unit communicates with a communication network. The auction providing unit presents a portion of plan information indicating a plan of content which is created by a content creator, presents the other plan information when a request is received from an advertiser who has browsed the portion of the plan information, and provides an auction service in which a bid target is a right to display an advertisement in an advertising space set to the content.

### CROSS-REFERENCE TO RELATED APPLICATIONS

The present application claims priority to and incorporates by reference the entire contents of Japanese Patent Application No. 2013-129514 filed in Japan on Jun. 20, 2013.

### BACKGROUND OF THE INVENTION

1. Field of the Invention

The present invention relates to an auction apparatus and an auction method.

2. Description of the Related Art

A distribution service has been known which distributes various kinds of content to a terminal apparatus of the user through the Internet. As an example of the distribution service, a moving image distribution service has been known which distributes moving image content and advertising content which is displayed in a display area of the moving image content.

In regard to the moving image distribution service, a technique which is called a program auction has been proposed. Specifically, in the program auction, after a program production company makes a presentation on a program, sponsors bid for a given amount of investment money. Then, only the sponsor who bids against the other sponsors has a broadcast right to a CM space for broadcasting hours. This program auction is used to make a definite promise to ensure funds beforehand.

However, in the related art, the content of the program is likely to be illegally used. Specifically, in the program auction, the program production company makes a presentation on the program and an auction is held. Therefore, in the program auction, an unauthorized person pretends to be a sponsor and can acquire the content of the program. Therefore, the content of the program is likely to be illegally used.

### SUMMARY OF THE INVENTION

According to one aspect of an embodiment, an auction apparatus includes a communication unit configured to communicate with a communication network; and a providing unit configured to present a portion of plan information indicating a plan of content which is created by a content creator through the communication network, configured to present the other plan information when a request is received from an advertiser who has browsed the portion of the plan information, and configured to provide an auction service in which a bid target is a right to display an advertisement in an advertising space set to the content.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of an auction process according to a first embodiment;

FIG. 2 is a diagram illustrating an example of the structure of an auction system according to the first embodiment;

FIG. 3 is a diagram illustrating an example of the structure of an auction apparatus according to the first embodiment;

FIG. 4 is a diagram illustrating an example of an auction storage unit according to the first embodiment;

FIG. 5 is a diagram illustrating an example of an advertiser information storage unit according to the first embodiment;

FIG. 6 is a diagram illustrating an example of an auction page generated by an auction providing unit according to the first embodiment;

FIG. 7 is a diagram illustrating an example of the auction page generated by the auction providing unit according to the first embodiment;

FIG. 8 is a sequence diagram illustrating the procedure of an auction process performed by the auction system according to the first embodiment;

FIG. 9 is a diagram illustrating an example of an auction process according to a modification of the first embodiment;

FIG. 10 is a diagram illustrating an example of an auction process according to a modification of the first embodiment;

FIG. 11 is a diagram illustrating an example of an auction storage unit according to a modification of the first embodiment;

FIG. 12 is a diagram illustrating an example of an auction page according to a modification of the first embodiment;

FIG. 13 is a diagram illustrating an example of an auction process according to a modification of the first embodiment;

FIG. 14 is a diagram illustrating an example of an auction page according to a modification of the first embodiment;

FIG. 15 is a diagram illustrating an example of an auction page according to a modification of the first embodiment;

FIG. 16 is a diagram illustrating an example of an auction page according to a modification of the first embodiment;

FIG. 17 is a diagram illustrating an example of the structure an auction apparatus according to a second embodiment;

FIG. 18 is a diagram illustrating an example of a verification process performed by a verifying unit according to the second embodiment;

FIG. 19 is a diagram illustrating an example of an auction process according to another embodiment;

FIG. 20 is a diagram illustrating an example of an auction process according to another embodiment;

FIG. 21 is a diagram illustrating an example of an auction process according to another embodiment;

FIG. 22 is a diagram illustrating an example of content according to another embodiment; and

FIG. 23 is a diagram illustrating an example of the hardware configuration of a computer which implements the functions of the auction apparatus.

### DETAILED DESCRIPTION OF THE PREFERRED EMBODIMENTS

Hereinafter, an auction apparatus, an auction method, and an auction program according to exemplary embodiments (hereinafter, referred to as “embodiments”) of the invention will be described in detail with reference to the accompanying drawings. The auction apparatus, the auction method, and the auction program according to the invention are not limited by the embodiments. In the following embodiments, the same components are denoted by the same reference numerals and the description thereof will not be repeated.

### First Embodiment

### 1. Auction Process

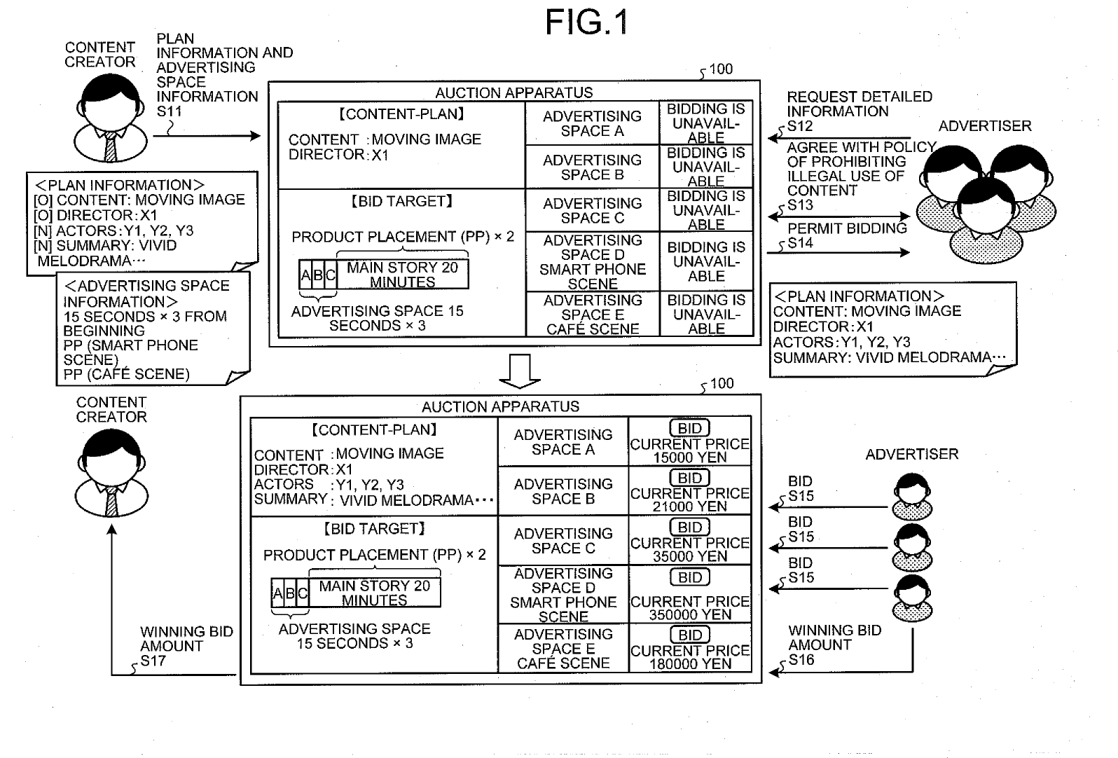

First, an example of an auction process according to a first embodiment will be described with reference to FIG. 1. FIG. 1 is a diagram illustrating an example of the auction process according to the first embodiment. The auction process performed by an auction apparatus 100 illustrated in FIG. 1 prevents the illegal use of a plan of content. Hereinafter, a moving image is given as an example of content.

As illustrated in the upper part of FIG. 1, the auction apparatus 100 receives plan information indicating a plan of a moving image and advertising space information relating to an advertising space which is set to the moving image by the content creator, from the content creator who plans to create the moving image (Step S11). In this case, the auction apparatus 100 receives the plan information in which information which can be presented to the advertiser without any conditions is designated. In the following description, in some cases, the plan of content (for example, the moving image) is referred to as a “content-plan”. The auction apparatus 100 may receive the plan information and the advertising space information at the same time or at different times.

In the example illustrated in FIG. 1, the plan information transmitted by the content creator includes information indicating that the type of content is a moving image, the director of the moving image is “X1”, the actors of the moving image are “Y1”, “Y2”, and “Y3”, and the summary of the moving image is a “vivid melodrama”. In addition, in the plan information illustrated in FIG. 1, information represented by a symbol “[O]” is permitted to be presented to the advertiser without any conditions and information represented by a symbol “[N]” is not permitted to be presented to the advertiser without any conditions. That is, the type or content or the director is permitted to be opened to the public, but the actor or summary is not permitted to be opened to the public. As such, in the example illustrated in FIG. 1, the content creator sets the items which can be opened to the public.

In the example illustrated in FIG. 1, the advertising space information transmitted by the content creator includes information relating to three advertising spaces which are set to the beginning of the moving image, an advertising space which is set to a scene in which a smart phone is used among various kinds of scenes included in the moving image, and an advertising space which is set to a café scene. A method which displays advertisements in the main story of the moving image so as to be associated with a specific scene or a specific actor is referred to as, for example, product placement.

When the plan information and the advertising space information are received, the auction apparatus 100 provides an auction service to the advertiser who agrees with the policy of prohibiting the illegal use of the content-plan. Specifically, the auction apparatus 100 provides an auction service in which a bid target, that is an item to be auctioned off, is a right to display advertisements in the advertising space of the moving image. Specifically, in an initial stage, the auction apparatus 100 presents only a portion of the plan information to the advertiser, with bidding being unavailable. In the example illustrated in the upper part of FIG. 1, when the advertiser accesses the auction apparatus 100, the auction apparatus 100 presents the advertiser information about the type of content and the director which are permitted to be presented without any conditions among various kinds of information included in the plan information.

Then, when the advertiser who has browsed a portion of the plan information requests the detailed information of the content-plan (Step S12), the auction apparatus 100 inquires the advertiser whether to agree with the police of prohibiting the illegal use of content-plan through, for example, a web page (Step S13). Then, the auction apparatus 100 permits the advertiser who has agreed with the police of prohibiting the illegal use of the content-plan to bid for the bid target to be auctioned off (Step S14).

Then, as illustrated in the lower part of FIG. 1, when the advertiser who has agreed with the police of prohibiting the illegal use of the content-plan accesses the auction apparatus 100, the auction apparatus 100 presents all plan information to the advertiser and provides the auction service which bids for the right to display advertisements in the advertising space of the moving image. That is, the auction apparatus 100 holds an auction in which the advertiser who has agreed with the police of prohibiting the illegal use of the content-plan is a bidder in the stage in which the content creator plans to create the moving image. In this case, as illustrated in the lower part of FIG. 1, the auction apparatus 100 individually provides the auction services related to each advertising space. Specifically, the auction apparatus 100 individually holds auctions for the advertising spaces A, B, and C displayed in the beginning of the moving image and the advertising spaces D and E displayed in the main story of the moving image.

Then, the auction apparatus 100 receives bids from the advertisers in each auction (Step S15). Then, the auction apparatus 100 determines the advertiser who bids the highest price for the period for which the auction is being held to be a winning bidder and receives the winning bid amount from the winning bidder (Step S16). Then, the auction apparatus 100 sends the winning bid amount received from the winning bidder to the content creator (Step S17). The subsequent process will be described in detail below. The auction apparatus 100 generates a moving image to be distributed by incorporating advertising data received from the winning bidder into the moving image created by the content creator.

As such, the auction apparatus 100 according to the first embodiment holds the auction in the stage in which the content creator plans to create a moving image and sends the winning bid amount to the content creator. Therefore, the auction apparatus 100 enables the content creator who plans to create content to raise funds for creation. For example, the auction apparatus 100 enables the content creator who is short of funds to raise funds for creation. Therefore, the auction apparatus 100 can support the creation of content by the content creator.

In addition, the auction apparatus 100 according to the first embodiment presents only a portion of the plan information and provides the auction service in which bidding is unavailable in the initial stage. Then, the auction apparatus 100 presents all plan information to the advertiser who has agreed with the policy of prohibiting the illegal use of the content-plan and provides the advertiser the auction service in which bidding is available. In this way, the auction apparatus 100 presents all plan information only to the advertiser who has agreed with the policy. Therefore, even when the auction service for the content which is planned to be created, it is possible to prevent the illegal use of the content-plan.

### 2. Structure of Auction System

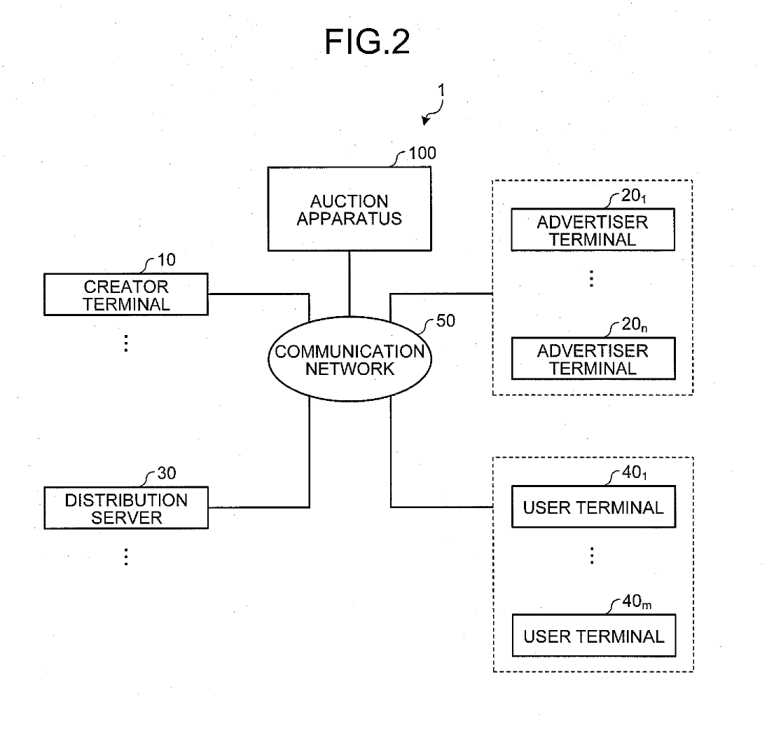

Next, the structure of the auction system according to the first embodiment will be described with reference to FIG. 2. FIG. 2 is a diagram illustrating an example of the structure of the auction system according to the first embodiment. As illustrated in FIG. 2, an auction system 1 includes a creator terminal 10, advertiser terminals 20₁ to 20ₙ, a distribution server 30, user terminals 40₁ to 40ₘ, and the auction apparatus 100. The creator terminal 10, the advertiser terminals 20₁ to 20ₙ, the distribution server 30, the user terminals 40₁ to 40ₘ, and the auction apparatus 100 are connected through a communication network 50 so as to communicate with each other wirelessly or by wire. The auction system 1 illustrated in FIG. 2 may include a plurality of creator terminals 10, a plurality of distribution servers 30, or a plurality of auction apparatuses 100.

The creator terminal 10 is an information processing apparatus which is used by the content creator. For example, the creator terminal 10 is operated by the content creator to transmit the plan information, the advertising space information, or content, such as a moving image created by the content creator, to the auction apparatus 100. In the following description, in some cases, the creator terminal 10 is referred to as a content creator. That is, in the following description, the content creator may be replaced with the creator terminal 10.

In some cases, the content creator requests an agent to transmit the plan information. In this case, the agent uses the auction service provided by the auction apparatus 100. Hereinafter, it is assumed that the term “content creator” includes the agent in addition to the content creator and the term “creator terminal” includes an agent terminal used by the agent in addition to the advertiser terminal.

The advertiser terminals 20₁ to 20ₙ are information processing apparatuses used by the advertisers. For example, the advertiser terminals 20₁ to 20ₙ are operated by the advertisers to acquire a web page (hereinafter, in some cases, referred to as an “auction page”) related to the auction service from the auction apparatus 100 or to transmit bid information or advertising data to the auction apparatus 100. In the following description, in some cases, when it is not necessary to distinguish the advertiser terminals 20₁ to 20ₙ, the advertiser terminals 20₁ to 20ₙ are generically referred to as an “advertiser terminal 20”. In addition, in the following description, in some cases, the advertiser terminal 20 is referred to as an advertiser, a bidder, or a winning bidder. That is, in the following description, the advertiser, the bidder, or the winning bidder may be replaced with the advertiser terminal 20.

In some cases, the advertiser requests the agent to perform a bid operation. In this case, the agent uses the auction service provided by the auction apparatus 100. In the following description, it is assumed that the term “advertiser” includes the agent in addition to the advertiser and the term “advertiser terminal” includes the agent terminal used by the agent in addition to the advertiser terminal.

The distribution server 30 is, for example, a web server. The distribution server 30 receives distribution target content from the auction apparatus 100. In addition, the distribution server 30 distributes the content received from the auction apparatus 100 in response to requests from the user terminals 40₁ to 40ₘ.

The user terminals 40₁ to 40ₘ are information processing apparatuses used by the users who browse content. For example, the user terminals 40₁ to 40ₘ are operated by the users to acquire content, such as a moving image, from the distribution server 30 and to display the acquired content on a display device (for example, a liquid crystal display). In the following description, when it is not necessary to distinguish the user terminals 40₁ to 40ₘ, the user terminals 40₁ to 40ₘ are generically referred to as a “user terminal 40”. In the following description, in some cases, the user terminal 40 is referred to as a user or a viewer. That is, in the following description, the user or the viewer may be replaced with the user terminal 40.

The auction apparatus 100 is, for example, a web server. As described with reference to FIG. 1, the auction apparatus 100 provides the auction service related to the advertising space which is incorporated into content in the planning stage.

The creator terminal 10, the advertiser terminal 20, or the user terminal 40 is implemented by, for example, a desktop personal computer (PC), a notebook PC, a tablet terminal, a mobile telephone, or a personal digital assistant (PDA).

### 3. Structure of Auction Apparatus

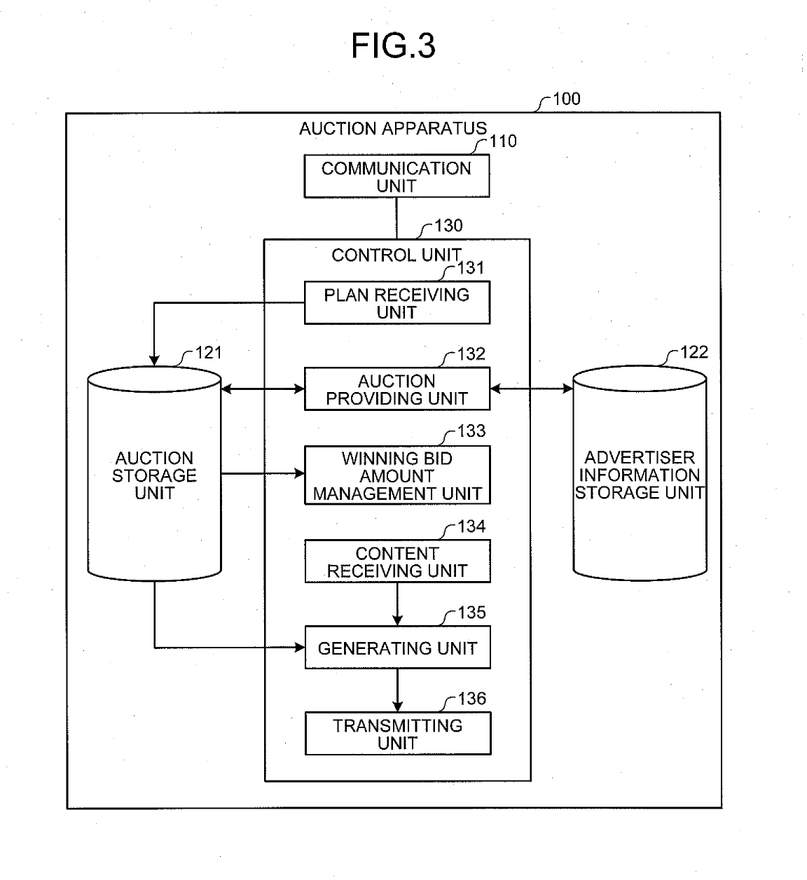

Next, the structure of the auction apparatus 100 according to the first embodiment will be described with reference to FIG. 3. FIG. 3 is a diagram illustrating an example of the structure of the auction apparatus 100 according to the first embodiment. As illustrated in FIG. 3, the auction apparatus 100 includes a communication unit 110, an auction storage unit 121, an advertiser information storage unit 122, and a control unit 130. In addition, the auction apparatus 100 may include an input unit (for example, a keyboard or a mouse) which receives various types of operations from the administrator of the auction apparatus 100 or a display unit (for example, a liquid crystal display) which displays various kinds of information.

The communication unit 110 is implemented by, for example, a network interface card (NIC). The communication unit 110 is connected to the communication network 50 wirelessly or by wire. The communication unit 110 transmits and receives information to and from the creator terminal 10, the advertiser terminal 20, or the distribution server 30 through the communication network 50.

The auction storage unit 121 is implemented by a semiconductor memory element, such as random access memory (RAM) or flash memory, or a storage device, such as a hard disk or an optical disk. The auction storage unit 121 according to the first embodiment stores various kinds of information used in the auction service.

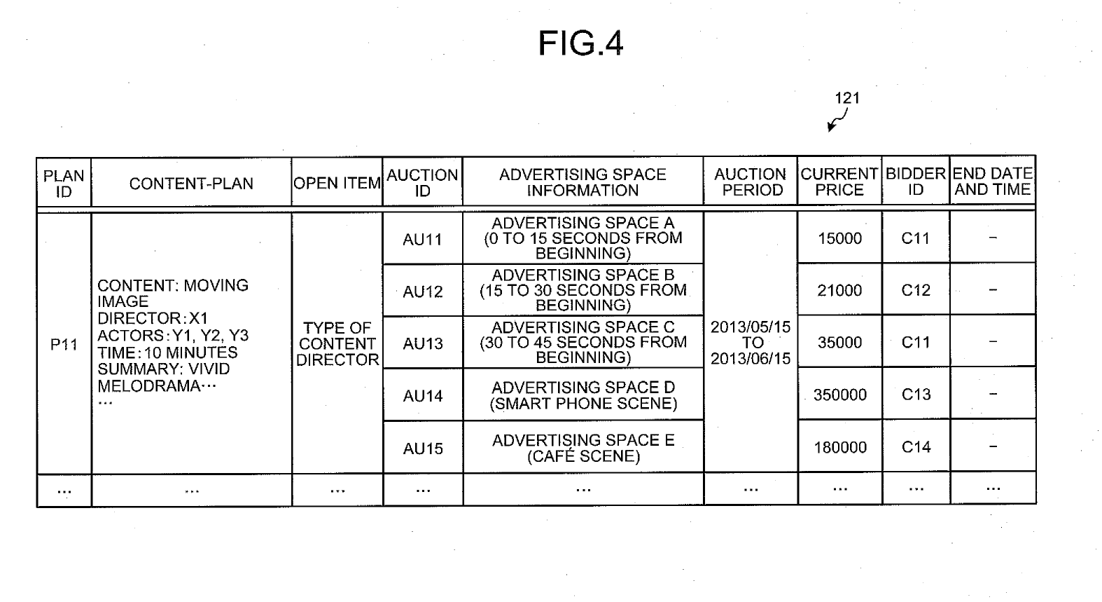

FIG. 4 illustrates an example of the auction storage unit 121 according to the first embodiment. In the example illustrated in FIG. 4, the auction storage unit 121 includes items, such as a “plan ID”, “content-plan”, an “open item”, an “auction ID”, “advertising space information”, an “auction period”, a “current price”, a “bidder ID”, and an “end date and time”.

The “plan ID” indicates identification information for identifying content which is planned to be created by the content creator. The “content-plan” indicates, for example, skeleton, details or the like of the content. The “open item” indicates an item which is permitted to be opened to the public without any conditions in the content-plan. The “auction ID” indicates identification information for identifying the auction related to each advertising space. In other words, the “auction ID” indicates identification information for identifying the advertising space. The “advertising space information” indicates information related to the advertising space incorporated into content. The “auction period” indicates the period for which the auction is held. The “current price” indicates the highest bid price of the auction at the present time. The “bidder ID” indicates identification information for identifying the bidder (that is, the advertiser) who bids the highest price at the present time. The “end date and time” indicates the date and time when the auction ends.

FIG. 4 illustrates an example in which an auction in which the date and time is not stored in the “end date and time” is being held or is not held and an auction in which the date and time is stored in the “end date and time” has ended. When the date and time is stored in the “end date and time”, the current price corresponds to the winning bid price and the bidder corresponds to the winning bidder. In addition, the information stored in the auction storage unit 121 is not limited to the example illustrated in FIG. 4. For example, the auction storage unit 121 may store information, such as a “creator ID” for identifying the content creator.

That is, FIG. 4 illustrates an example in which the content identified by a plan ID “P11” is planned to be created and the planned content is a moving image. In addition, in the example illustrated in FIG. 4, information about the type of content (in this example, a moving image) and the director of the content in the content-plan is permitted to be opened to the public without any conditions. In the example illustrated in FIG. 4, five advertising spaces A to E are incorporated into the content. In the example illustrated in FIG. 4, the auction related to the advertising space A is identified by an auction ID “AU11” and the auctions related to the advertising spaces B to E are identified by auction IDs “AU12”, “AU13”, “AU14”, and “AU15”, respectively. In the example illustrated in FIG. 4, each auction related to the advertising spaces A to E is being held or it is not held. As such, the auction storage unit 121 stores the auction IDs corresponding to the advertising spaces incorporated into the content so as to be associated with one plan ID (that is, content in the planning stage).

The advertiser information storage unit 122 is implemented by a semiconductor memory element, such as RAM or flash memory, or a storage device, such as a hard disk or an optical disk. The advertiser information storage unit 122 according to the first embodiment stores information about the advertiser who is permitted to use the auction service.

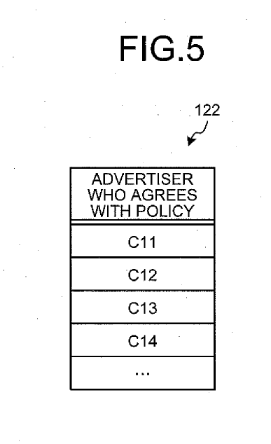

FIG. 5 illustrates an example of the advertiser information storage unit 122 according to the first embodiment. In the example illustrated in FIG. 5, the advertiser information storage unit 122 includes an item such as an “advertiser who agrees with policy”. The “advertiser who agrees with policy” indicates an advertiser ID for identifying the advertiser who agrees with the policy of prohibiting the illegal use of the content-plan. That is, in the example illustrated in FIG. 5, the advertisers identified by advertiser IDs “C11”, “C12”, “C13”, and “C14” agree with the policy of prohibiting the illegal use of the content-plan and can use the auction service in which bidding is available.

For example, a central processing unit (CPU) or a micro processing unit (MPU) executes various programs (an example of an auction program) stored in a storage device of the auction apparatus 100, using the RAM as a work area, to implement the functions of the control unit 130. In addition, the control unit 130 is implemented by an integrated circuit, such as an application specific integrated circuit (ASIC) or a field programmable gate array (FPGA).

As illustrated in FIG. 3, the control unit 130 includes a plan receiving unit 131, an auction providing unit 132, a winning bid amount management unit 133, a content receiving unit 134, a generating unit 135, and a transmitting unit 136 and performs or implements the following information processing function or operation. The internal structure of the control unit 130 is not limited to that illustrated in FIG. 3, but the control unit 130 may have any structure as long as it can perform the following information processing. In addition, the connection relation between the processing units of the control unit 130 is not limited to that illustrated in FIG. 3, but other connection relations may be established between the processing units.

The plan receiving unit 131 receives the plan information and the advertising space information from the content creator who plans to create content. Specifically, the plan receiving unit 131 receives, from the content creator, the plan information indicating the content-plan and the advertising space information about the advertising space which is set to the content by the content creator. Then, when the plan information and the advertising space information are received, the plan receiving unit 131 outputs a new plan ID and also outputs an auction ID for each advertising space set to the content. Then, the plan receiving unit 131 stores the plan information in the “content-plan” and the “open item” of the auction storage unit 121 so as to be associated with the new plan ID. In addition, the plan receiving unit 131 stores the auction ID for each advertising space in the auction storage unit 121 so as to be associated with the plan ID and stores the advertising space information in the “advertising space information” of the auction storage unit 121 so as to be associated with each auction ID. In this case, the plan receiving unit 131 may store the creator ID corresponding to the content creator, who is a transmission source of the plan information and the advertising space information, in the auction storage unit 121. The creator ID is transmitted together with, for example, the plan information and the advertising space information by the content creator. Alternatively, when a login is required to use various types of services provided by the auction apparatus 100, the login ID of the content creator may be used as the creator ID.

The plan receiving unit 131 analyzes, for example, the plan information to extract information corresponding to items, such as the type, director, and actors of content, or information about whether each item can be opened to the public. For example, when the plan information is described by a markup language such as an extensible markup language (XML), the plan receiving unit 131 can easily extract the information corresponding to each item or the information about whether each item can be opened to the public from the plan information. When the format of the plan information is predetermined, the plan receiving unit 131 can easily extract various kinds of information from the plan information on the basis of the predetermined format. Similarly, when the advertising space information is described by the markup language or when the format of the advertising space information is predetermined, the plan receiving unit 131 can easily extract various kinds of information from the advertising space information.

The plan receiving unit 131 may receive the advertising space information including the auction period set by the content creator. In this case, the plan receiving unit 131 stores the auction period included in the advertising space information in the auction storage unit 121. However, the invention is not limited to this example, but the plan receiving unit 131 may store a predetermined auction period in the auction storage unit 121. For example, the plan receiving unit 131 may use, as the auction period, the period until a predetermined number of days elapse from the date and time when the plan information and the advertising space information are received.

The plan receiving unit 131 may provide an input site for inputting the plan information or the advertising space information to the content creator. For example, the plan receiving unit 131 provides an input site for inputting the type of content or the content-plan. In this case, the plan receiving unit 131 divides the input site into an input form for inputting the content-plan which may be presented to the advertiser without any conditions and an input form for inputting the content-plan which may be presented only to the advertiser who has agreed with the policy. In addition, for example, the plan receiving unit 131 provides an input site for inputting a temporal position (hereinafter, in some cases, referred to as a reproduction position) where the advertising space is reproduced, the reproduction time of the advertising space, or the display size of the advertising space. In this case, the plan receiving unit 131 receives various kinds of information input to the input site as the plan information and the advertising space information.

The auction providing unit 132 presents the plan information received by the plan receiving unit 131 and provides the auction service which bids for a right to display advertisements in the content. Specifically, the auction providing unit 132 presents a portion of the plan information received by the plan receiving unit 131, presents the other plan information when a request is received from the advertiser who has browsed a portion of the plan information, and provides the auction service.

Specifically, when an auction page acquisition request is received from the advertiser terminal 20 of the advertiser, the auction providing unit 132 determines whether the advertiser ID of the advertiser has been stored in the advertiser information storage unit 122. For example, the advertiser terminal 20 transmits the advertiser ID and the acquisition request. Alternatively, when a login is required to use various types of services provided by the auction apparatus 100, the login ID of the advertiser may be used as the advertiser ID.

Then, when the advertiser ID has not been stored in the advertiser information storage unit 122, the auction providing unit 132 determines that the auction page acquisition request has been received from the advertiser who has not agreed with the policy of prohibiting the illegal use of the content. In this case, the auction providing unit 132 extracts the plan information corresponding to the open item from the content-plan stored in the auction storage unit 121 and provides an auction page having the extracted plan information inserted thereinto to the advertiser terminal 20. In this case, the auction providing unit 132 provides the auction page into which the information about the advertising space is also inserted, on the basis of the advertising space information stored in the auction storage unit 121. However, the auction providing unit 132 provides the auction page in which bidding is unavailable at this point of time.

On the other hand, when the advertiser ID of the advertiser who has transmitted the acquisition request has been stored in the advertiser information storage unit 122, the auction providing unit 132 determines that the auction page acquisition request has been received from the advertiser who agrees with the policy of prohibiting the illegal use of the content. In this case, the auction providing unit 132 provides the auction page into which the content-plan stored in the auction storage unit 121 is inserted to the advertiser terminal 20. At that time, the auction providing unit 132 provides the auction page which includes information about the advertising space and in which bidding is available. Then, the auction providing unit 132 receives bid information including a bid price from the advertiser terminal 20 through the auction page. In this case, the auction providing unit 132 stores the bid price included in the bid information in the auction storage unit 121 so as to be associated with an auction ID indicating the auction corresponding to a bid target. The auction providing unit 132 also stores the advertiser ID corresponding to the bidder, which is a transmission source of the bid information, in the bidder ID of the auction storage unit 121.

An example of the process performed by the auction providing unit 132 will be described. For example, the auction providing unit 132 transmits a list of the content-plan stored in the auction storage unit 121 to the advertiser terminal 20. The auction providing unit 132 receives an acquisition request including the plan ID which corresponds to the content-plan selected from the transmitted list from the advertiser terminal 20. In this case, the auction providing unit 132 acquires various kinds of information corresponding to the plan ID in the acquisition request from the auction storage unit 121. In the example illustrated in FIG. 4, the auction providing unit 132 acquires, from the auction storage unit 121, the content-plan and the auction period corresponding to the plan ID, and the advertising space information, the current price, the bidder ID, and the end date and time for each auction ID corresponding to the plan ID. Then, the auction providing unit 132 determines whether the advertiser ID is stored in the advertiser information storage unit 122 as described above, generates an auction page using various kinds of information acquired from the auction storage unit 121, and provides the generated auction page to the advertiser terminal 20.

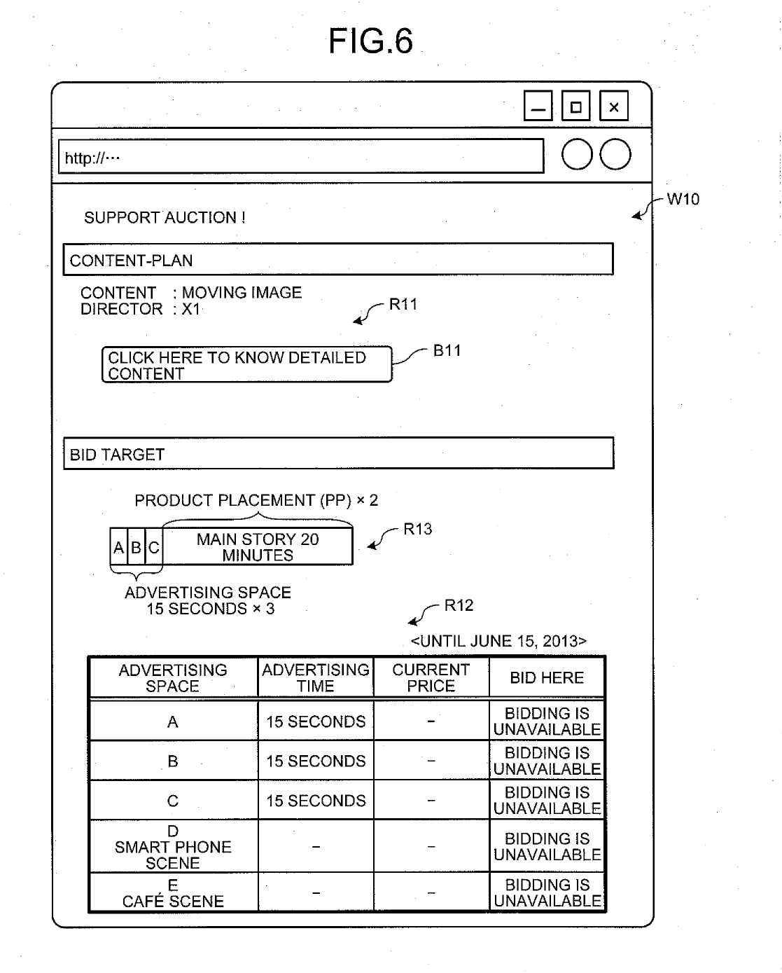

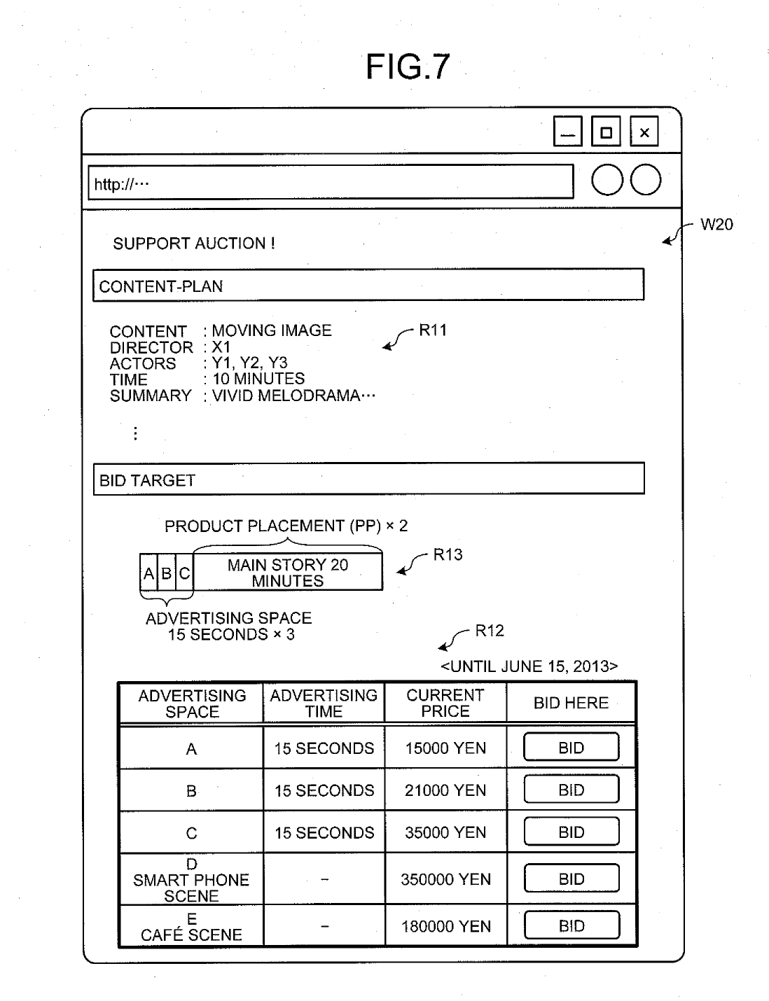

FIGS. 6 and 7 illustrate examples of the auction page generated by the auction providing unit 132 according to the first embodiment. FIGS. 6 and 7 illustrate an example of an auction page corresponding to the plan ID “P11” illustrated in FIG. 4. FIG. 6 illustrates an example of an auction page W10 in which bidding is unavailable. FIG. 7 illustrates an example of an auction page W20 in which bidding is available.

As in the example illustrated in FIG. 6, when an auction page acquisition request is received from the advertiser who does not agree with the police of prohibiting the illegal use of content, the auction providing unit 132 inserts the plan information corresponding to the open item in the content-plan which is stored in the auction storage unit 121 into a plan display field R11 of the auction page W10. In addition, the auction providing unit 132 inserts a detail acquisition button B11 for acquiring the detailed content-plan into the plan display field R11. The auction providing unit 132 inserts the advertising space information for each auction ID which is stored in the auction storage unit 121 so as to be associated with the plan ID “P11” into a bid display field R12 of the auction page W10 such that bidding is not available. In addition, the auction providing unit 132 inserts an image diagram in which the reproduction position of the advertising space is visible into an image display field R13 of the auction page W10. In the example illustrated in FIG. 6, the auction providing unit 132 inserts information about the position of the advertising space or the time of the advertising space in the moving image, but does not insert the current bid price.

As such, when the advertising space information includes information about a plurality of advertising spaces, the auction providing unit 132 inserts all advertising space information into the auction page W10 and individually holds the auctions related to each advertising space.

In the example illustrated in FIG. 6, when the detail acquisition button 311 is pressed, the auction providing unit 132 provides the advertiser terminal 20 a policy page for selecting whether to agree with the policy of prohibiting the illegal use of the content-plan. When an operation of agreeing with the policy is performed on the policy page, the auction providing unit 132 stores the advertiser ID of the advertiser who has performed the operation in the advertiser information storage unit 122. On the other hand, when an operation which does not agree with the policy is performed on the policy page, the auction providing unit 132 does not store the advertiser ID of the advertiser who has performed the operation in the advertiser information storage unit 122.

As in the example illustrated in FIG. 7, when the auction page acquisition request is received from the advertiser who agrees with the policy of prohibiting the illegal use of the content, the auction providing unit 132 inserts all of the content-plan which is stored in the auction storage unit 121 into the plan display field R11 of the auction page W20. In addition, the auction providing unit 132 inserts the advertising space information stored in the auction storage unit 121 into the bid display field R12 of the auction page W20 such that bidding is available.

Although not illustrated in the drawings, when the bid button displayed in the bid display field R12 of the auction page W20 is pressed, the auction providing unit 132 provides a bid page for inputting the bid price to the advertiser terminal 20. Then, the auction providing unit 132 receives bid information including the bid price from the advertiser terminal 20 through the bid page.

The auction page is not limited to those illustrated in FIGS. 6 and 7. For example, the auction providing unit 132 may insert the name of the content creator into the plan display field R11 of the auction page W20. For example, the content creator may set the target amount of the winning bid price as an estimated cost required to create content to the plan information. In this case, the auction providing unit 132 may insert the target amount of the winning bid price into the plan display field R11. For example, the auction providing unit 132 may not insert the image diagram into the image display field R13 of the auction pages W10 and W20.

The winning bid amount management unit 133 manages the winning bid amount received from the winning bidder who has successfully bid the right to display advertisements. Specifically, even when the winning bid amount is received from the winning bidder, the winning bid amount management unit 133 instantly stores the entire winning bid amount, without sending the winning bid amount to the content creator. Whenever the content creator charges for the creation of content, the winning bid amount management unit 133 sends the amount of money corresponding to the charge from the stored reserve price to the content creator. For example, the winning bid amount management unit 133 receives, from the creator terminal 10, charge data, such as clothing expenses, filming expenses, or food expenses which have been actually used to create content, or charge data, such as clothing expenses, filming expenses, or food expenses which will be used to create content immediately. Then, the winning bid amount management unit 133 sends the amount of money corresponding to the received charge data to the content creator. The winning bid amount management unit 133 manages the winning bid amount using the current price (that is, the highest bid price) stored in the auction storage unit 121.

As such, the winning bid amount management unit 133 does not instantly send the winning bid amount received from the winning bidder to the content creator, but gradually sends the winning bid amount in response to a request from the content creator. Therefore, the winning bid amount management unit 133 can prevent the winning bid amount from being sent to the content creator who does not create the content. As a result, the winning bid amount management unit 133 can prevent the abuse of the auction service provided by the auction apparatus 100.

When the total amount of money charged by the content creator is less than the winning bid amount, the winning bid amount managed by the winning bid amount management unit 133 is left. In this case, the winning bid amount management unit 133 may send the surplus money to the content creator after the content creator creates content. Therefore, the winning bid amount management unit 133 pays the content creator for the creation of the content, which makes it possible to improve the creative will of the content creator.

The content receiving unit 134 receives the content corresponding to the plan information from the content creator. For example, when the content creator which has transmitted the plan information completes content, the content receiving unit 134 receives the completed content. In addition, the content receiving unit 134 receives advertising data which is incorporated into the advertising space from the winning bidder who has successfully bid for the right to display advertisements.

The winning bidder has the right to display the advertisements. However, the winning bidder may transfer the right to other advertisers. In this case, the content receiving unit 134 receives advertising data from the advertiser who has the right to display advertisements, in addition to the winning bidder. It is assumed that the term ‘winning bidder’ includes the advertiser to which the right to display advertisements is transferred.

The generating unit 135 combines the content and the advertising data received from the content receiving unit 134 to generate composite content. Specifically, the generating unit 135 incorporates advertising data corresponding to the advertiser who has the right to display advertisements in the advertising space which is set to the content created by the content creator into the advertising space on the basis of the advertising space information, thereby generating the composite content.

The transmitting unit 136 transmits the composite content generated by the generating unit 135 to the distribution server 30. Then, the distribution server 30 distributes the composite content having the advertising data incorporated thereinto to the user terminal 40 in response to a request from the user terminal 40.

### 4. Procedure of Auction Process

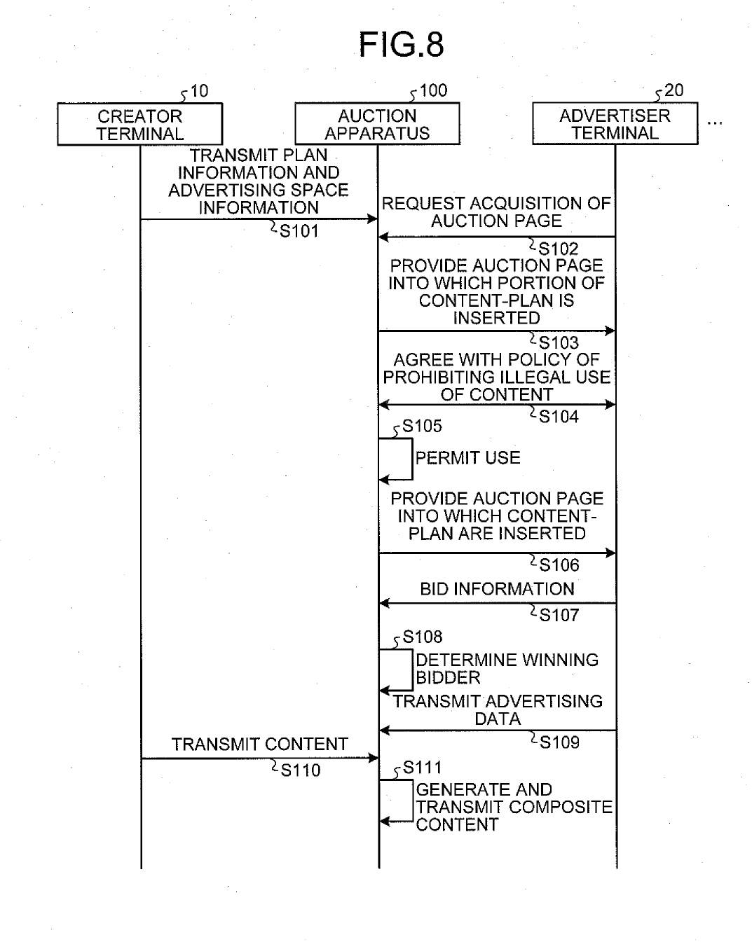

Next, the procedure of the auction process performed by the auction system 1 according to the first embodiment will be described with reference to FIG. 8. FIG. 8 is a sequence diagram illustrating the procedure of the process performed by the auction system 1 according to the first embodiment. FIG. 8 illustrates only one advertiser terminal 20. However, in practice, there are a plurality of advertiser terminals 20.

As illustrated in FIG. 8, the content creator transmits the plan information and the advertising space information to the auction apparatus 100 using the creator terminal 10 (Step S101). In this case, the auction apparatus 100 stores the plan information and the advertising space information in the auction storage unit 121.

Then, when an auction page acquisition request is received from the advertiser terminal 20 (Step S102), the auction apparatus 100 provides the auction page into which some of the content-plan are inserted to the advertiser terminal 20 (Step S103). Then, the auction apparatus 100 inquires the advertiser whether to agree with the policy of prohibiting the illegal use of content (S104). Here, it is assumed that the advertiser agrees with the policy of prohibiting the illegal use of content. In this case, the auction apparatus 100 stores the advertiser ID of the advertiser in the advertiser information storage unit 122 to permit the advertiser to bid in the auction (Step S105).

Then, when the advertiser who has agreed with the policy of prohibiting the illegal use of content accesses the auction apparatus 100, the auction apparatus 100 provides the auction page into which all of the content-plan are inserted to the advertiser terminal 20 (Step S106). Then, the auction apparatus 100 receives the bid information including the bid price from the advertiser terminal 20 through the auction page (Step S107). In this way, the auction apparatus 100 receives the bid information from a plurality of advertiser terminals 20.

Then, the auction apparatus. 100 determines the winning bidder on the basis of the bid information received from the advertiser terminals 20 (Step S108). For example, the auction apparatus 100 determines the advertiser who bids the highest price at the date and time when the auction has ended to be the winning bidder. Then, the auction apparatus 100 manages the winning bid amount received from the winning bidder. Then, when the content creator charges for the cost of production, the auction apparatus 100 subtracts the cost from the winning bid amount and sends the cost to the content creator.

The winning bidder transmits advertising data to the auction apparatus 100 using the advertiser terminal 20 (Step S109). When the content has been created, the content creator transmits the content to the auction apparatus 100 using the creator terminal 10 (Step S110).

The auction apparatus 100 incorporates the advertising data received from the advertiser into the content received from the content creator to generate composite content and transmits the generated composite content to the distribution server 30 (Step S111).

### 5. Modifications

The first embodiment is not limited to the above-mentioned structure, but various other structures can be configured. Next, the modifications of the first embodiment will be described.

5-1. Selection by Content Creator

In the first embodiment, the advertiser can bid in the auction at the time when the advertiser agrees with the policy of prohibiting the illegal use of content. However, the auction apparatus 100 may inquire the content creator whether bidding is available.

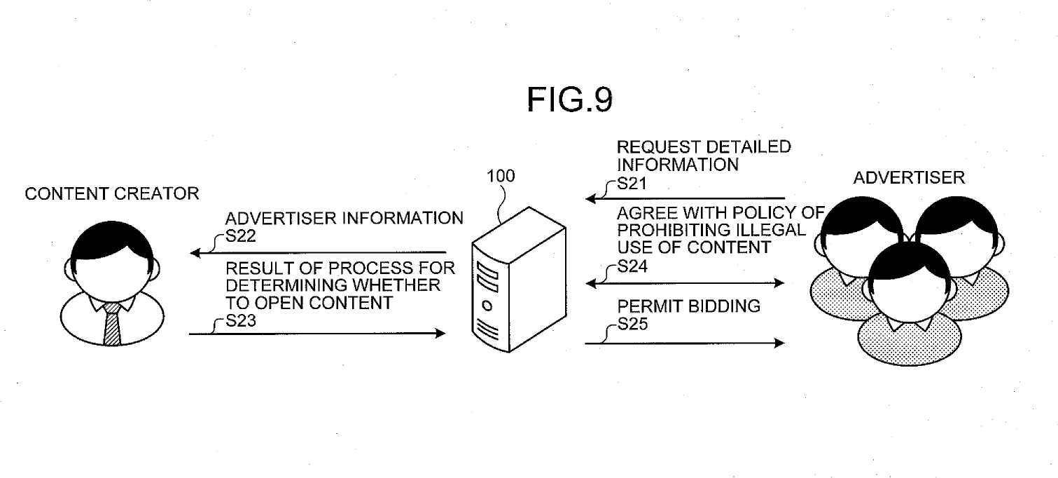

This will be described with reference to FIG. 9. FIG. 9 is a diagram illustrating an example of an auction process according to a modification of the first embodiment. As illustrated in FIG. 9, when the advertiser requests the detailed information of the content-plan (Step S21), the auction apparatus 100 transmits advertiser information about the advertiser to the content creator (Step S22). For example, when the advertiser is a company, the auction apparatus 100 transmits, for example, the name of the company or the type of business thereof as the advertiser information. Then, the auction apparatus 100 inquires the content creator whether to open all of the content-plan to the advertiser.

Then, the content creator determines whether to open all of the content-plan to the advertiser on the basis of the advertiser information and transmits the determination result to the auction apparatus, 100 (Step S23). When the content creator determines to open all of the content-plan to the advertiser, the auction apparatus 100 transmits the policy page to the advertiser. When the advertiser agrees with the policy of prohibiting the illegal use of the content-plan (Step S24), the auction apparatus 100 permits the advertiser to bid in the auction (Step S25). On the other hand, when the content creator does not permit to open all of the content-plan to the advertiser, the auction apparatus 100 does not transmit the policy page to the advertiser and does not permit the advertiser to bid in the auction.

As such, since the auction apparatus 100 opens all of the content-plan only to the advertiser which is permitted by the content creator. Therefore, it is possible to reduce the possibility of the content-plan being illegally used. In addition, the content creator can allow only the desired advertiser to participate in the auction. Therefore, it is possible to incorporate advertisements corresponding to the content-plan which is planned to be created into the content. For example, when moving image content related to a car is created, the content creator allows only the advertiser related to a car business to participate in the auction. Therefore, it is possible to incorporate advertisements corresponding to moving image content into the content and thus give unity to the moving image content.

In Step S23 of FIG. 9, the auction apparatus 100 may inquire the content creator of the items of the content-plan to be opened to the advertiser. That is, the auction apparatus 100 may select the disclosure level of the content-plan for each advertiser. Therefore, the auction apparatus 100 can provide the auction service which can select the disclosure level of the content-plan.

5-2. Intermediation Between Content Creator and Advertiser

In the first embodiment, the auction apparatus 100 may be configured such that the advertiser designate the desired genre of content and the content creator selects the advertiser who can participate in the auction on the basis of the desired genre.

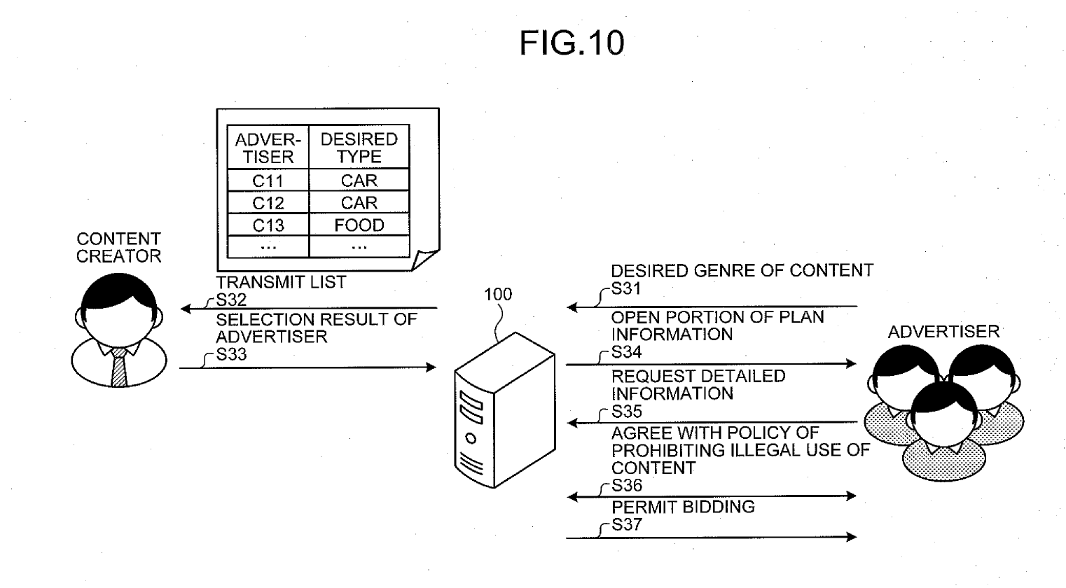

This will be described with reference to FIG. 10. FIG. 10 is a diagram illustrating an example of an auction process according to a modification of the first embodiment. As illustrated in FIG. 10, the auction apparatus 100 receives the genre of the content in which the advertiser wants to display advertisements from the advertiser (Step S31). In this example, the auction apparatus 100 receives the desired genre from a plurality of advertisers in advance. Then, for example, when the content creator accesses the auction apparatus 100, the auction apparatus 100 transmits a list of the correspondence between the advertisers and the desired genre to the content creator (Step S32).

Then, the content creator selects one or more advertisers who can participate in the auction on the basis of the list of the correspondence and transmits the selection result to the auction apparatus 100 (Step S33). For example, the content creator selects the advertiser whose desired genre corresponds to the content-plan which is planned to be created. Then, when the advertiser selected by the content creator accesses the auction apparatus 100, the auction apparatus 100 provides the auction page W10 illustrated in FIG. 6 and opens a portion of the plan information to the advertiser (Step S34). The subsequent Steps S35 to S37 are the same as Steps S12 to S14 illustrated in FIG. 1.

When the advertiser which is not selected by the content creator accesses the auction apparatus 100, the auction apparatus 100 does not open the plan information and notifies the advertiser that the advertiser cannot participate in the auction.

As such, the auction apparatus 100 intermediates between the content creator and the advertisers and connects the content creator and the advertiser who agree with their request. Therefore, the auction apparatus 100 can improve the degree of satisfaction of both the content creator and the advertiser. In Step S32, the auction apparatus 100 may transmit a list of the advertisers corresponding to the genre of the content which is planned to be created by the content creator. In this case, the auction apparatus 100 can connect the content creator and the advertiser who agree with their request.

5-3. Subject Determining Items to be Opened

In the first embodiment, the plan information in which the items to be opened are set is received from the content creator. That is, in the first embodiment, the content creator sets the items to be opened. However, the invention is not limited thereto, but the auction apparatus 100 may determine the items to be opened. For example, the plan receiving unit 131 provides the content creator the input site for inputting the plan information or the advertising space information, as described above. In this case, the plan receiving unit 131 allows the content creator to input various kinds of information for each item related to content, such as the type of content, a director, and actors. Then, the auction providing unit 132 may use a predetermined item (for example, the type or content and a director) among various kinds of information input to the input site as the item to be opened. In this case, the plan receiving unit 131 may insert the items to be opened into the input site.

5-4. Items to be Opened

In the first embodiment, a portion of the content-plan is not opened to the advertiser who does not agree with the policy. However, the auction providing unit 132 may not open information about the advertising space to the advertiser who does not agree with the policy. In this case, the auction providing unit 132 may not all information (for example, the number of advertising spaces and the reproduction position) about the advertising space or it may not open a portion of information (for example, the reproduction position of the advertising space) about the advertising space. The item to be opened in the information about the advertising space may be determined by the content creator or the auction apparatus 100.

In the first embodiment, the auction providing unit 132 may display closed information so as to be obscured by a mosaic. In this case, the auction providing unit 132 may constantly open an item name in the content-plan to the public. For example, in the example illustrated in FIG. 7, the auction providing unit 132 may display the item names, such as “content”, a “director”, “actors”, a “time”, and a “summary”, in the content-plan on the auction page and display, for example, information “moving image” corresponding to the content, information “X1” corresponding to the director, or information “Y1, Y2, and Y3” corresponding to the actors so as to be obscured by a mosaic.

5-5. Gradual

In the first embodiment, the plan receiving unit 131 may gradually receive the plan information. For example, the plan receiving unit 131 may receive a first plan information item which can be opened to the advertisers without any conditions and then receive a second plan information item which can be opened only to the advertiser who has agreed with the policy. Then, the auction providing unit 132 opens the first plan information item to all of the advertisers and opens the second plan information item only to the advertiser who has agreed with the policy. Therefore, the content creator can transmit a brief version of the content-plan as the first plan information items to the auction apparatus 100 and then transmit a detailed version of the content-plan as the second plan information item to the auction apparatus 100. Therefore, the auction apparatus 100 can implement a practical auction for the content creator who plans to create content.

5-6. Notification of Holding of Auction

In the first embodiment, the date when each auction is held may not be set. That is, the content creator may set information, such as “not set”, to the auction period of the advertising space information. In this case, after the advertising space information in which “not set” is set to the auction period is received, the plan receiving unit 131 receives the advertising space information in which the detailed range of the date and time is set to the auction period at an arbitrary time. That is, the content creator may not set the auction period and may then set the detailed range of the date and time to the auction period. In this case, when the auction period is set, the auction providing unit 132 may notify the advertiser who has agreed with the policy (that is, the advertiser whose advertiser ID has been stored in the advertiser information storage unit 122) that the auction has been held.

5-7. Determination of Reliability

In the first embodiment, the auction apparatus 100 may store auction log information about the content creator or the advertiser who has used the auction service provided by the auction providing unit 132 in the past. For example, the auction apparatus 100 may store, as the auction log information, the creation result of content by the content creator, the money received by the advertiser, the evaluation of the content creator by the advertiser, or the evaluation of the advertiser by the content creator. The auction apparatus 100 may open the auction log information to the content creator or the advertiser. For example, the auction apparatus 100 may transmit the auction log information to the content creator, in addition to the list of the correspondence between the advertiser and the desired genre, in Step S32 of FIG. 10. Therefore, the content creator can select the advertiser with a good reputation on the basis of the auction log information. In addition, for example, the auction apparatus 100 may transmit the auction log information to the advertiser to designate a specific content creator. In this way, the auction apparatus 100 can connect the content creator and the advertiser who agree with their request.

5-8. Right to Bid

In the first embodiment, only the advertiser who has agreed with the policy of prohibiting the illegal use of content can bid in the auction. However, the auction apparatus 100 may allow the advertiser who does not agreed with the policy of prohibiting the illegal use of content to bid in the auction, with only a portion of the content-plan opened to the public. For example, when the advertiser who does not agreed with the policy of prohibiting the illegal use of content accesses the auction apparatus 100, the auction apparatus 100 may provide an auction page into which only a portion of the content of an advertisement is inserted and in which bidding is available. The auction apparatus 100 makes it easy for a large number of advertisers to participate in the auction and can increase the number of bidders.

5-9. Policy

In the first embodiment, the policy of prohibiting the illegal use of the content-plan is given as an example. However, the policy is not limited thereto. For example, the auction apparatus 100 may open all of the content-plan to the advertiser who has agreed with the policy of prohibiting the leakage of the content-plan, in addition to the policy of prohibiting the illegal use of the content-plan.

5-10. Auction Period

In the first embodiment, when a plurality of advertising spaces are set to one content item, the periods for which the auctions related to each advertising space are held are equal to each other. However, the auction providing unit 132 may provide an auction service in which an auction related to some advertising spaces among the plurality of advertising spaces and an auction related to the other advertising spaces are held at different start date and times. For example, when a plurality of advertising spaces are set to content, the auction providing unit 132 may allow the content creator to set the period for which each auction related to each advertising space is held. The auction providing unit 132 may hold the auction for the period which is set to each auction. In the first embodiment, a buyout price or a reserve price may be set to the auction related to each advertising space.

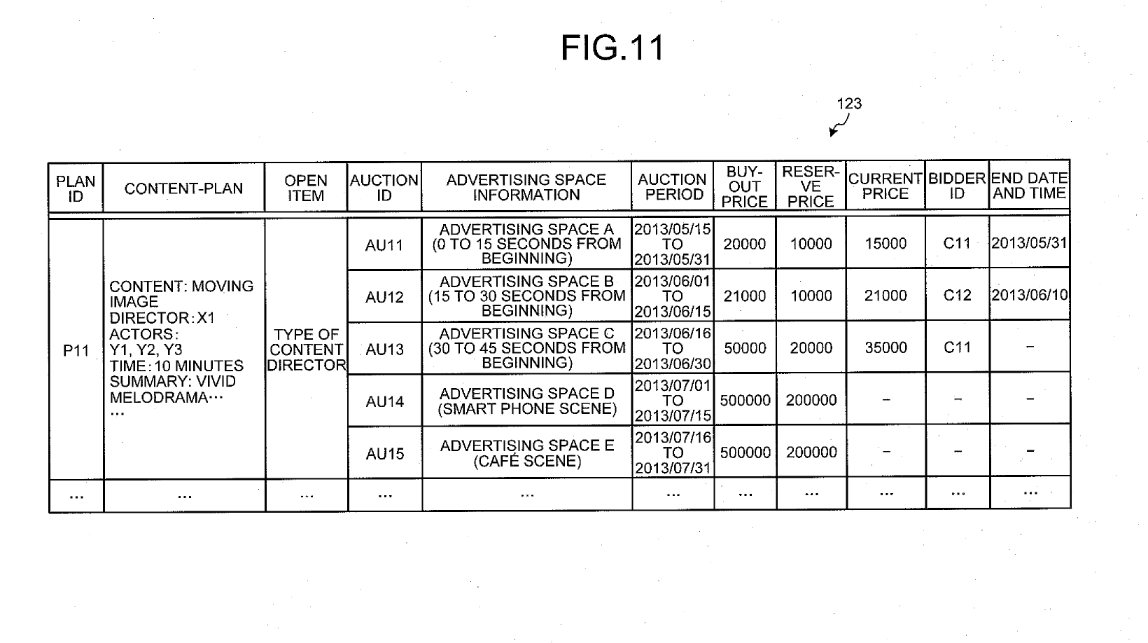

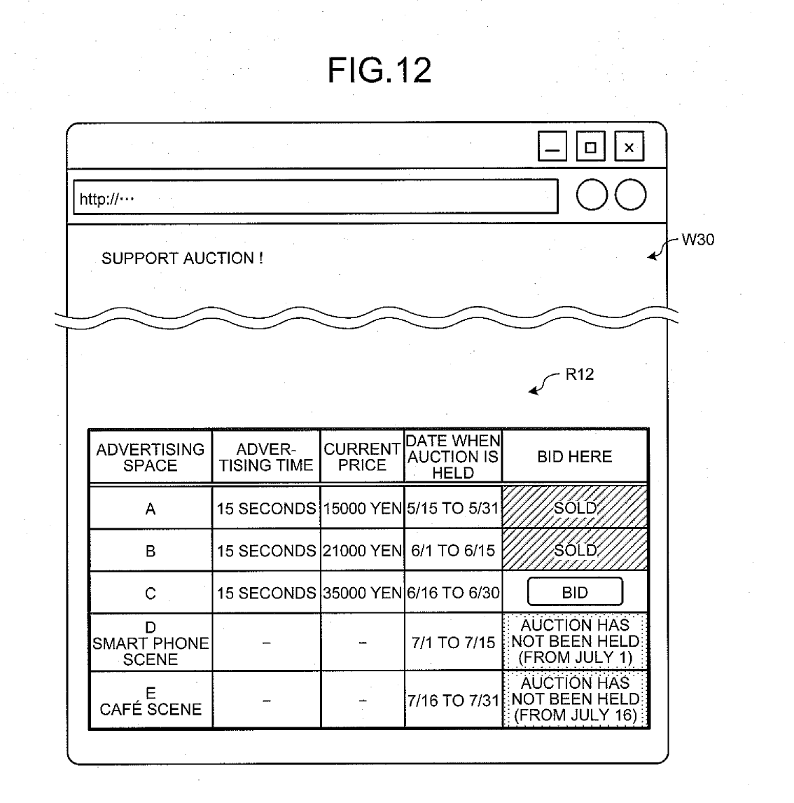

This will be described with reference to FIGS. 11 and 12. FIG. 11 is a diagram illustrating an example of an auction storage unit 123 according to a modification of the first embodiment. An auction apparatus 100 according to the modification includes the auction storage unit 123 illustrated in FIG. 11, instead of the auction storage unit 121 illustrated in FIG. 4. As illustrated in FIG. 11, the auction storage unit 123 stores information, such as an “auction period”, “buyout price”, and a “reserve price”, for each advertising space.

The “auction period” indicates the period for which the auction related to each advertising space is held. The “buyout price” indicates a price at which a bid target (that is, the right to display advertisements in the advertising space) can be instantly knocked down. The “reserve price” indicates the minimum price at which a bid target can be knocked down. The “auction period”, the “buyout price”, and the “reserve price” are included in, for example, the advertising space information which is transmitted from the creator terminal 10 to the auction apparatus 100 and is set by the content creator.

That is, FIG. 11 illustrates an example in which the auction related to an advertising space A for the period from 0 second to 15 seconds from the beginning of a moving image is held from “5/15/2013” to “5/31/2013”. In the example illustrated in FIG. 11, the buyout price of the auction related to the advertising space A is “20000 yen” and the reserve price is “10000 yen”. In the example illustrated in FIG. 11, the auction related to an advertising space B is held from “6/1/2013” to “6/15/2013”, the auction related to an advertising space C is held from “6/16/2013” to “6/30/2013”, the auction related to an advertising space D is held from “7/1/2013” to “7/15/2013”, and the auction related to an advertising space F is held from “7/16/2013” to “7/31/2013”. As such, in the example illustrated in FIG. 11, the auctions related to the advertising spaces A to E are held for different periods.

In the example illustrated in FIG. 11, since date and time information is stored in the end date and time corresponding to the advertising space A, the auction related to the advertising space A has ended. In this case, the winning bid price of the auction related to the advertising space A is “15000 yen” and the winning bidder of the auction is the advertiser identified by a bidder ID “C11”. Similarly, in the example illustrated in FIG. 11, the auction related to the advertising space B has ended. The buyout price of the auction related to the advertising space B is “21000 yen” and the auction ended on “6/10/2013” before “6/15/2013” which was the end date of the auction.

In the example illustrated in FIG. 11, since no date and time information is stored in the end date and time corresponding to the advertising spaces C to E, each auction corresponding to the advertising spaces C to E has not ended. It is assumed that the present date is any one of “6/16/2013” to “6/30/2013” and the auction corresponding to the advertising space C is being held.

FIG. 12 illustrates an example of an auction page according to a modification of the first embodiment. FIG. 12 illustrates an example of an auction page W30 corresponding to a plan ID “P11” illustrated in FIG. 11. As illustrated in FIG. 12, the auction providing unit 132 inserts information indicating that the items have been sold at the auction corresponding to the advertising space A and the auction corresponding to the advertising space B into a bid display field R12 of the auction page W30. In addition, the auction providing unit 132 inserts information indicating that bidding is available at the auction related to the advertising space C and the auction related to the advertising space D and the auction related to the advertising space E are not held.

As such, the auction apparatus 100 may hold the auctions related to each advertising space which is set to one content item for different periods. Therefore, the auction apparatus 100 enables the advertiser to check the conditions of the item which has been knocked down at the auction related to some advertising spaces among a plurality of advertising spaces set to one content item and hold the auctions related to the other advertising spaces. For example, the advertiser refers to the winning bid price of the auction which has ended to check a change in the winning bid price. When the auctions are held at different periods, it is considered that last-minute bidding is likely to occur at an auction which is held late and the winning bid price is likely to rise. Therefore, the advertiser can place a bid in the auction which is held early to buy an item at a low price.

In the example illustrated in FIG. 12, the auction providing unit 132 may insert, for example, the buyout price or the reserve price as information about the auction. In addition, the auction providing unit 132 may insert bid increment when the bid increment indicating the amount of money to be added to the current bid price is determined. The bid increment may vary depending on the auction related to each advertising space or it may be the same in all auctions. In addition, the bid increment may be set by the content creator or it may be predetermined in the auction apparatus 100.

In the example illustrated in FIG. 11, the auction period is not necessarily set to the auctions related to all of the advertising spaces. For example, the content creator may set information, such as “not set”, as the advertising space information to some or all of the auction periods of the advertising spaces set to the content. In this case, the auction providing unit 132 inserts information, such as “not set”, into the date of the auction related to the advertising space whose auction period is not set among the dates of the auctions in the auction page W30. Therefore, the auction apparatus 100 enables the advertisers to know that the date of the auction is not set. In this example, the plan receiving unit 131 receives the advertising space information in which the auction period is not set and then receives the advertising space information in which the detailed range of the date and time is set to the auction period at a given time. That is, first, the content creator does not set the auction period and then sets the detailed range of the date and time to the auction period. Therefore, the content creator can set the period for which the value of the advertising space which varies depending on, for example, the reputation of the content-plan is high as the auction period. As a result, it is possible to raise desired funds.

5-11. Target Price

In the modification illustrated in FIGS. 11 and 12, the plan receiving unit 131 may receive the advertising space information including the target price of the winning bid price from the content creator. The auction providing unit 132 may adjust the buyout price in the auction to be held, on the basis of the winning bid price in the auction which has ended among the auctions corresponding to a plurality of advertising spaces and the target price received by the plan receiving unit 131.

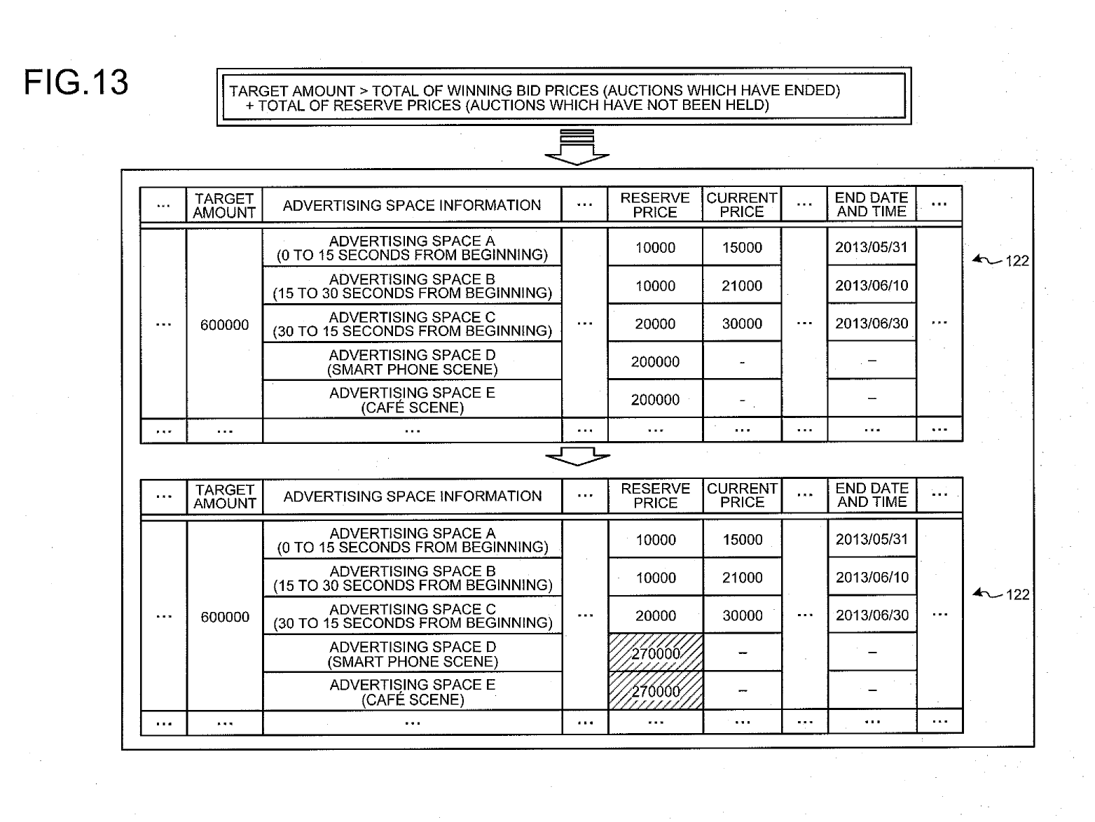

This will be described with reference to FIG. 13. FIG. 13 is a diagram illustrating an example of an auction process according to the modification of the first embodiment. The auction storage unit 123 illustrated on the upper side of FIG. 13 further stores the target price received by the plan receiving unit 131, as compared to the example illustrated in FIG. 11. Although not illustrated in FIG. 13, the auction storage unit 123 illustrated in FIG. 9 also stores other items, such as the “plan ID” and the “plan of content” illustrated in FIG. 11.

FIG. 13 illustrates an example in which the plan receiving unit 131 receives the target price corresponding to the total of the winning bid prices in each auction. In this, example, the content creator desires the total of the winning bid prices in the auctions related to the advertising spaces A to E to reach a target price of “600000 yen”.

When any one of a plurality of auctions which are held for different periods ends, the auction providing unit 132 determines whether the total of the winning bid prices in the auctions reaches the target price. For example, the auction providing unit 132 adds “the total of the winning bid prices in the auctions which have ended at the present time” and “the total of the reserve prices in the auctions which have not been held” and determines whether the addition result is less than the target price. When the addition result is less than the target price, the auction providing unit 132 raises the reserve price in the auctions which have not been held.

For example, in the auction storage unit 123 illustrated on the upper side of FIG. 13, “the total of the winning bid prices in the auctions which have ended at the present time” is “66000 yen” and “the total of the reserve prices in the auctions which have not been held” is “400000 yen”. That is, the addition result of the totals is “466000 yen” and is less than the target price “600000 yen′”. Therefore, the auction providing unit 132 raises the reserve prices in the auctions which have not been held, as illustrated on the lower side of FIG. 13. In this case, the auction providing unit 132 raises the reserve price corresponding to the advertising space D from “200000 yen” to “270000 yen” and raises the reserve price corresponding to the advertising space E from “200000 yen” to “270000 yen”. In this way, “the total of the reserve prices in the auctions which have not been held” is “540000 yen”. That is, the addition result is “606000 yen” and is more than the target price “600000 yen”.

As such, the auction apparatus 100 can adjust the reserve prices in the auctions which have not been held, depending on the winning bid prices in the auctions which have ended, to increase the possibility of the winning bid price reaching the target price. As a result, the auction apparatus 100 can increase the possibility of the content creator raising desired funds.

In the example illustrated in FIG. 13, the auction providing unit 132 raises the reserve price. However, the auction providing unit 132 may reduce the reserve price. For example, when the addition result of “the total of the winning bid prices in the auctions which have ended at the present time” and “the total of the reserve prices in the auctions which have not been held” is more than the target price, the auction providing unit 132 may reduce the reserve prices in the auctions which have not been held in the range in which the addition result reaches the target price. In this case, the auction apparatus 100 can increase the possibility that an item will be sold in the auction which has not been held. Therefore, the auction apparatus 100 enables the content creator to raise desired funds.

In the example illustrated in FIG. 13, the auction providing unit 132 may not adjust the reserve price, but may adjust the buyout price. For example, when the addition result of “the total of the winning bid prices in the auctions which have ended at the present time” and “the total of the reserve prices in the auctions which have not been held” is less than the target price, the auction providing unit 132 may raise the buyout price in the auction which has not been held such that the addition result reaches the target price. For example, when the addition result is more than the target price, the auction providing unit 132 may reduce the buyout price in the auction which has not been held in the range in which the addition result reaches the target price. In addition, the auction providing unit 132 may adjust both the reserve price and the buyout price.

In the example illustrated in FIG. 13, when all of the auctions have ended, the auction providing unit 132 may determine whether the total of the winning bid prices in each auction reaches the target price. When the total of the winning bid prices does not reach the target price, the auction providing unit 132 may cancel all auctions. For example, in the example illustrated in FIG. 13, when the auctions corresponding to the advertising spaces A to E are concluded, but the total of the winning bid prices does not reach the target price “600000 yen”, the auction providing unit 132 cancels all auctions corresponding to the advertising spaces A to E. In this case, when the winning bid amount is received from the winning bidder, the winning bid amount management unit 133 returns the winning bid amount to the winning bidder. Therefore, only when the content creator can raise desired funds, the auction apparatus 100 can conclude the auction.

In the example illustrated in FIG. 13, the periods for which the auctions are held are different from each other. However, even when all auctions are held for the same period, the auction apparatus 100 may receive the target price from the content creator. In this case, the auction apparatus 100 may perform a process which does not conclude all auctions.

When the auctions are held for the same period, but a bid is made at the buyout price, the times when the auctions end are different from each other. Therefore, even when the auctions are held for the same period, but some auctions have ended early, the auction apparatus 100 may perform a process of adjusting the reserve price or the buyout price.

In the first embodiment, whenever receiving billing data from the content creator, the winning bid amount management unit 133 sends the billing amount to the content creator. However, when the total of the winning bid prices reaches the target price, the winning bid amount management unit 133 may send the amount of money corresponding to the target price to the content creator, without receiving the billing data.

5-12. Display of Bidder

In the modification illustrated in FIGS. 11 and 12, the auction providing unit 132 may notify information about the bidder on the auction page. Specifically, the auction providing unit 132 may display information about the bidder on the auction page. For example, the auction providing unit 132 may display the type of business or the company name of the bidder who is the advertiser.

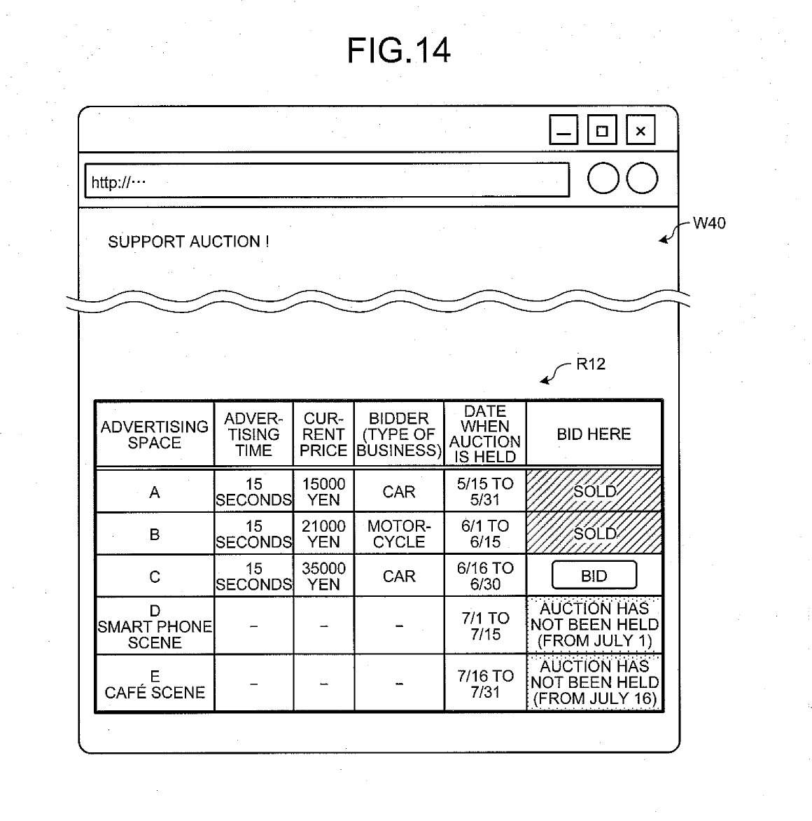

This will be described with reference to FIG. 14. FIG. 14 is a diagram illustrating an example of an auction page according to the modification of the first embodiment. As illustrated in FIG. 14, the auction providing unit 132 inserts the type of business of the bidder in each auction into a bid display field R12 of an auction page W40. In the example illustrated in FIG. 14, the auction related to the advertising space A and the auction related to the advertising space B have ended and the auction related to the advertising space C is being held. The type of business, “car”, of the winning bidder in the auction related to the advertising space A, the type of business, “motorcycle”, of the winning bidder in the auction related to the advertising space B, and the type of business, “car”, of the winning bidder who is the highest bidder in the auction related to the advertising space C are displayed in the auction page W40 illustrated in FIG. 14. It is assumed that the auction apparatus 100 stores various kinds of information (for example, the type of business and the company name) about the bidder who is the advertiser.

As such, the auction apparatus 100 can display information about the bidder or the winning bidder to provide reference information in bidding to the advertiser who is a bidder. For example, in the example illustrated in FIG. 14, it is considered that the winning bidder who is engaged in the “car” or “motorcycle” business determines that the content planned to be created is browsed by the user with high preference to the “car” or the “motorcycle”. Therefore, for example, the advertiser who is engaged in the “travel” business determines that the user with high preference to the “car” or the “motorcycle” has high preference to the “travel” and can bid in the auction related to the advertising space C which is being held.

5-13. Bid Target

In the first embodiment, the advertising spaces are allocated to different reproduction positions in the moving image. That is, in the first embodiment, the advertising space is distinguished by the reproduction position. However, the invention is not limited thereto, but the advertising space may be distinguished by, for example, the distribution period for which advertising data is distributed or the targeting conditions used during the distribution of the advertising data.

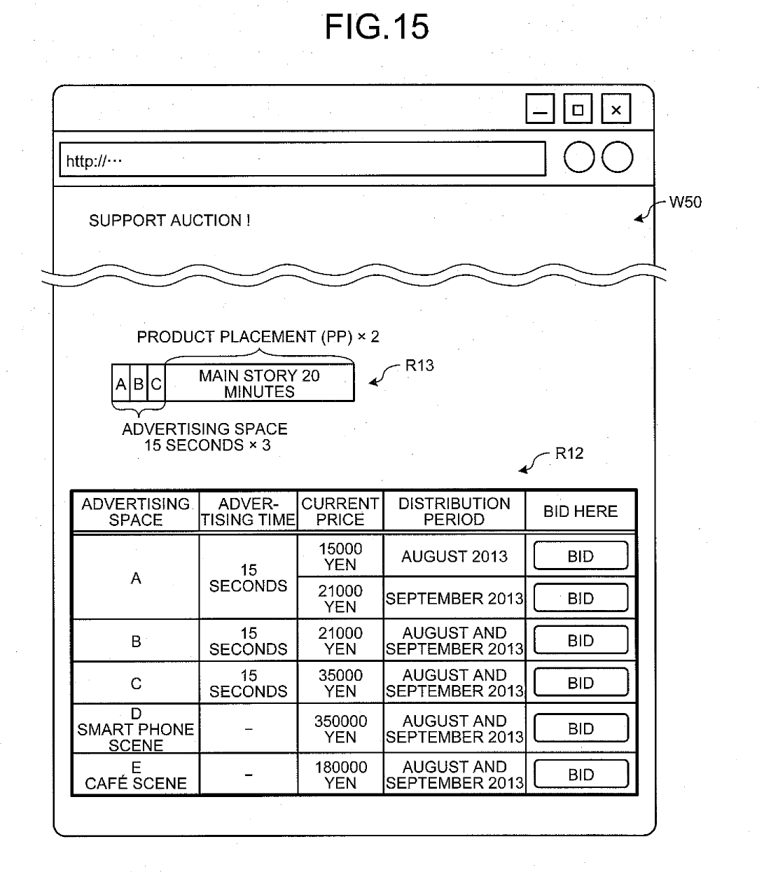

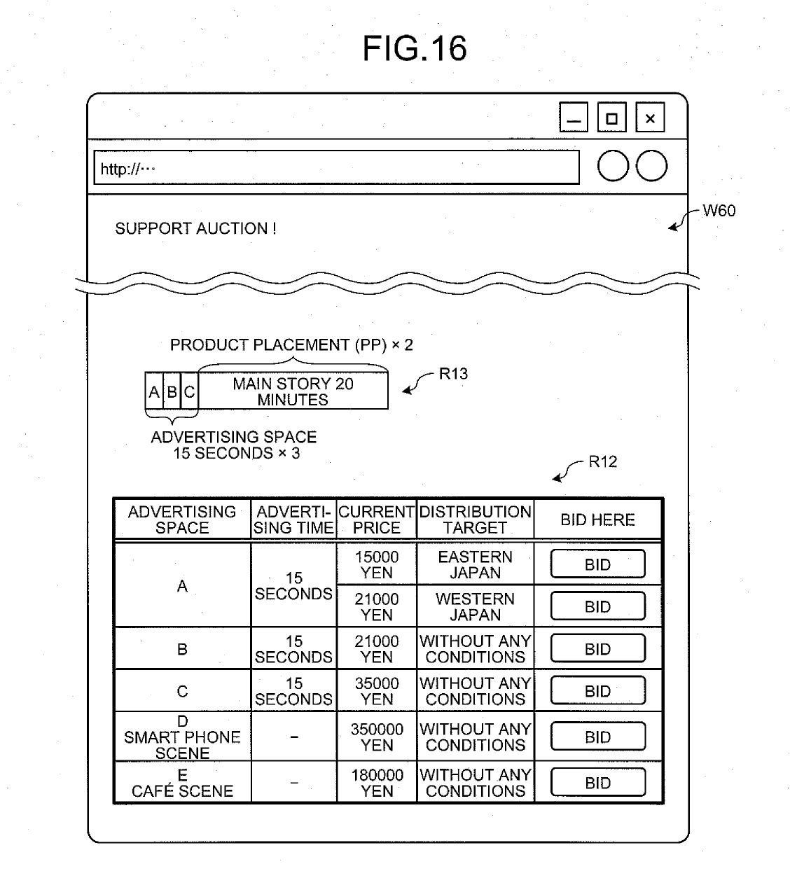

This will be described with reference to FIGS. 15 and 16. FIGS. 15 and 16 are diagrams illustrating examples of the auction page according to the modification of the first embodiment. In the example illustrated in FIG. 15, the advertising space A which is displayed for the period from 0 second to 15 seconds from the beginning of the moving image is divided into two advertising spaces. Specifically, the advertising space A is divided into an advertising space including information indicating that advertisements are distributed on August 2013 and an advertising space including information indicating that advertisements are distributed on September 2013. In this case, the advertiser determines the bid target from the two advertising spaces A on the basis of the period for which the advertiser wants to distribute advertisements.

Next, the example illustrated in FIG. 16 will be described. It is assumed that advertisements to be distributed vary depending on the distribution destination of content. In the example illustrated in FIG. 16, the advertising space A which is displayed for the period from 0 second to 15 seconds from the beginning of the moving image is divided into an advertising space in which advertisements are distributed to the users in eastern Japan and an advertising space in which advertisements are distributed to the users in western Japan. In this case, the advertiser determines the bid target from the two advertising spaces A on the basis of the distribution of advertisements.

As such, the auction apparatus 100 may distinguish the advertising spaces set to the same reproduction position using the targeting conditions, such as the distribution period or distribution destination of advertisements. In this case, the auction apparatus 100 can increase the choices of the advertiser and improve the degree of satisfaction of the advertiser.

The auction providing unit 132 divides the advertising space as in the example illustrated in FIG. 15 or FIG. 16 on the basis of the advertising space information received from the creator terminal 10. That is, the content creator determines whether to divide the advertising space on the basis of the display period or distribution destination of advertisements.

The targeting conditions for distinguishing the advertising space are not limited to the display period or distribution destination of advertisements, but may be various kinds of user attributes, such as psychographic attributes or demographic attributes. For example, the advertising space set to the same reproduction position may be divided into an advertising space in which advertisements are distributed to the male users and an advertising space in which advertisements are distributed to the female users. For example, the advertising space set to the same reproduction position may be divided into an advertising space in which advertisements are distributed to the user with relatively high preference to a car, an advertising space in which advertisements are distributed to the user with relatively high preference to travel, and an advertising space in which advertisements are distributed to the user with relatively high preference to cosmetics.

In the examples illustrated in FIGS. 15 and 16, the generating unit 135 generates composite content for each combination of the advertising spaces. For example, in the example illustrated in FIG. 16, the generating unit 135 combines the advertising spaces A (eastern Japan), B, C, D, and B to generate composite content and combines the advertising spaces A (western Japan), B, C, D, and E to generate composite content. Then, the transmitting unit 136 transmits the two composite content items generated by the generating unit 135 to the distribution server 30.

5-14. Additional Fee

In the first embodiment, the winning bid amount management unit 133 sends the winning bid amount received from the winning bidder to the content creator. However, the invention is not limited thereto. When the number of times the distribution server 30 distributes the composite content to the user terminal 40 is greater than a predetermined value, the winning bid amount management unit 133 may charge the advertiser, which corresponds to the advertising data incorporated in the composite content, an additional fee. That is, when the number′ of times the composite content is browsed is greater than a predetermined value, the winning bid amount management unit 133 may charge the advertiser an additional fee. When the additional fee is received from the advertiser, the winning bid amount management unit 133 may send the received additional fee to the content creator. In this case, when the composite content is popular, the auction apparatus 100 pays the additional fee to the content creator. Therefore, it is possible to improve the creative will of the content creator. When the advertiser is charged the additional fee, the auction providing unit 132 inserts information indicating that an additional fee is likely to be charged into the auction page. For example, the auction providing unit 132 inserts a note that “when the number of times the content is browsed is greater than N, an additional fee of M yen is charged” or a note that “when the number of times the content is browsed is greater than N, an additional fee is charged depending on the number of times the content is browsed” into the auction page. Therefore, the auction apparatus 100 informs the advertiser that an additional fee is charged in advance. The notes may be set to the plan information by the content creator or it may be predetermined in the auction apparatus 100.

5-15. Fee

In the first embodiment, the auction apparatus 100 may collect a fee from the advertiser who uses the auction service. For example, when providing the auction page W10 illustrated in FIG. 6 to the advertiser, the auction apparatus 100 may collect a fee for the use of the system from the advertiser. As such, the auction apparatus 100 collects a fee when the advertiser browses the content-plan, which makes it possible to prevent the user who has no intention of participating in the auction from browsing the content-plan. For example, when the winning bidder is determined and the auction is concluded, the auction apparatus 100 may collect a fee from the advertiser who is the winning bidder. In addition, the auction apparatus 100 may collect a fee from the content creator. For example, the auction apparatus 100 may collect a fee from the content creator when the plan information or the advertising space information is received from the content creator.

### 6. Effect

As described above, the auction apparatus 100 according to the first embodiment includes the plan receiving unit 131 and the auction providing unit 132. The plan receiving unit 131 receives the plan information indicating the content-plan from the content creator who creates the content. The auction providing unit 132 opens a portion of the plan information received by the plan receiving unit 131 and opens the other plan information in response to a request from the advertiser who has browsed a portion of the plan information. Then, the auction providing unit 132 provides the auction service which bids for the right to display advertisements in the advertising space set to the content.

Therefore, even when the auction service for the content which is planned to be created is provided, the auction apparatus 100 according to the first embodiment can prevent the content-plan from being illegally used.

When a plurality of advertising spaces are set to content, the auction providing unit 132 according to the first embodiment manages the auctions related to each advertising space so as to be associated with the plan information (which corresponds to an example of the plan ID) corresponding to the content.

Therefore, the auction apparatus 100 according to the first embodiment can manage a plurality of auctions corresponding to one content-plan item so as to be associated with each other. For example, the auction apparatus 100 manages each auction so as to be associated with one content-plan item. Therefore, it is possible to adjust, for example, the buyout price or the reserve price, as in the above-mentioned example.

### Second Embodiment

In a second embodiment, an example in which the consistency between composite content distributed to a distribution server 30 and the plan of content is verified will be described. The structure of an auction system 1 according to the second embodiment is the same as that illustrated in FIG. 2 and the description thereof will not be repeated.

### 1. Structure of Auction Apparatus

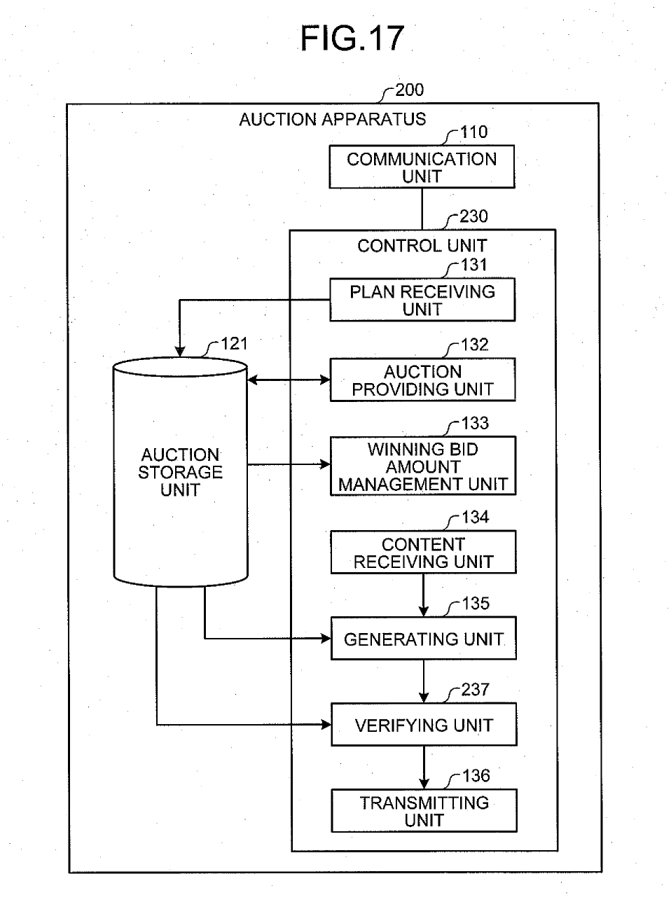

The structure of an auction apparatus 200 according to the second embodiment will be described with reference to FIG. 17. FIG. 17 is a diagram illustrating an example of the structure of the auction apparatus 200 according to the second embodiment. As illustrated in FIG. 17, a control unit 230 of the auction apparatus 200 includes a verifying unit 237.

The verifying unit 237 verifies the consistency between composite content generated by a generating unit 135 and the content-plan indicated by plan information. Specifically, when composite content is generated by the generating unit 135, the verifying unit 237 verifies whether the generated composite content is consistent with the content-plan and advertising space information stored in an auction storage unit 121.

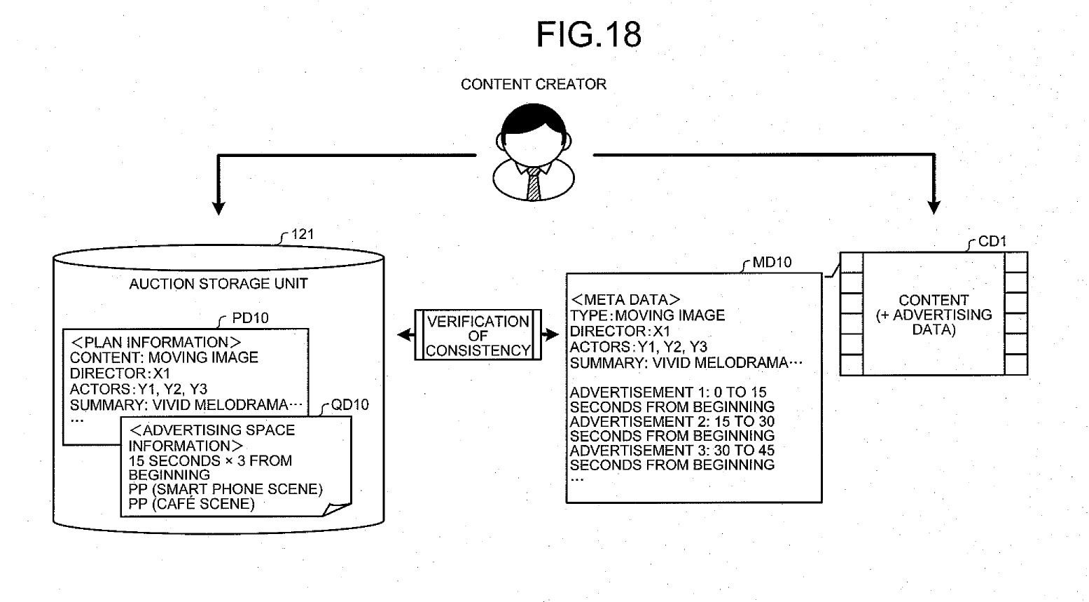

FIG. 18 illustrates an example of a verification process performed by the verifying unit 237 according to the second embodiment. In the example illustrated in FIG. 18, a plan receiving unit 131 receives plan information PD10 and advertising space information QD10 and stores the received information in an auction storage unit 121. The generating unit 135 incorporates advertising data received from a winning bidder into the content created by a content creator to generate composite content CD1. Meta data MD10 indicating the content of a moving image is given to the composite content CD1. In the example illustrated in FIG. 18, the meta data MD10 includes information about the type of content, a director, and actors and information about the reproduction position of an advertising space.

In this situation, the verifying unit 237 analyzes the meta data MD10 and extracts keywords corresponding to items, such as the type of content, the director, the actors, and the reproduction position of the advertising space. For example, when the meta data MD10 is described by a markup language, the verifying unit 237 can easily extract the keywords corresponding to each item from the meta data MD10. Then, the verifying unit 237 verifies whether the plan information PD10 and the advertising space information QD10 stored in the auction storage unit 121 are identical to the keywords extracted from the meta data MD10 for each item.

When the number of items in which the keywords are not identical to the information is equal to or greater than a predetermined threshold value, the verifying unit 237 determines that the composite content is not consistent with the content-plan or the advertising space information. In this case, the verifying unit 237 does not output the composite content to the transmitting unit 136, notifies a creator terminal 10 of the content creator that there is no consistency therebetween, and ends the process. When the verifying unit 237 determines that there is no consistency therebetween, the winning bid amount management unit 133 returns the winning bid amount to the winning bidder. When it is determined that there is the consistency therebetween, the verifying unit 237 outputs the composite content to the transmitting unit 136.

Examples of the item whose consistency is verified by the verifying unit 237 include the “type of content”, the “plan of content (for example, the director, the actors, and the summary)”, the “number of advertising spaces”, the “reproduction position of an advertising space”, the “reproduction time of an advertising space”, and the “size of an advertising space”. In addition, for example, when the plan information includes a deadline for creating the content, the verifying unit 237 verifies whether the content is created within the deadline.

The verifying unit 237 may store result information indicating whether the content which is consistent with the plan of the content or the advertising space information is generated, for each content creator. The auction providing unit 132 according to the second embodiment may pay a penalty to the content creator who has created inconsistent content a number of times more than a predetermined value, on the basis of the result information stored by the verifying unit 237. For example, the auction providing unit 132 may pay a penalty for preventing the posting of the plan information and the advertising space information or a penalty for preventing the distribution server 30 from distributing the created content to the user terminal 40.

### 2. Effect

As described above, the auction apparatus 200 according to the second embodiment includes the verifying unit 237. The verifying unit 237 verifies the consistency between the composite content generated by the generating unit 135 and the content-plan indicated by the plan information.

Therefore, the auction apparatus 200 according to the second embodiment can determine whether the content creator creates content according to the plan. Therefore, it is possible to provide a high-reliability auction service to the advertisers.

### Other Embodiments

Various structures other than the structures according to the above-described embodiments may be configured. Hereinafter, other embodiments will be described. Next, other embodiments will be described using the auction apparatus 100 as an example, but the following other embodiments may be applied to the auction apparatus 200.

### 1. Confirmation of Composite Content

In the above-described embodiments, when the composite content is generated, the auction apparatus 100 may make the content creator or the advertiser confirm the content of the composite content item.

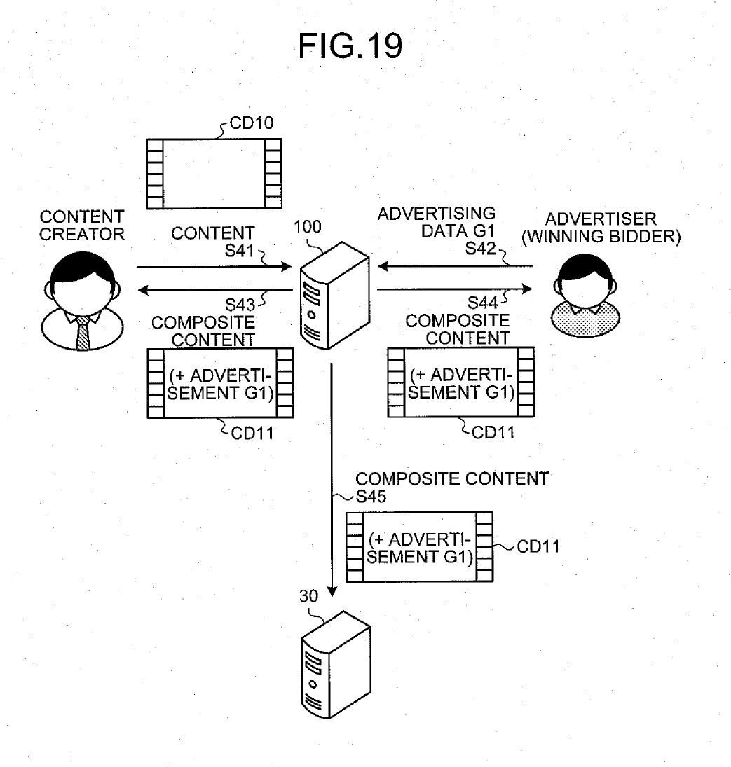

This will be described with reference to FIG. 19. FIG. 19 is a diagram illustrating an example of an auction process according to another embodiment. In the example illustrated in FIG. 19, the auction apparatus 100 receives content CD10 from the content creator (Step S41) and receives advertising data G1 from the advertiser (Step S42). Then, the auction apparatus 100 incorporates the advertising data G1 into the content CD10 to generate composite content CD11.

The transmitting unit 136 of the auction apparatus 100 transmits the composite content CD11 to the content creator and the advertiser before transmitting the composite content CD11 to the distribution server 30 (Steps S43 and S44). In this way, the transmitting unit 136 inquires the content creator and the advertiser whether there is a problem on the composite content CD11. Then, when a response indicating that there is no problem in the composite content CD11 is received from the content creator and the advertiser, the transmitting unit 136 transmits the composite content CD11 to the distribution server 30 (Step S45).

As such, the auction apparatus 100 makes the content creator and the winning bidder confirm the composite content, which makes it possible to prevent the unintended composite content of the content creator and the winning bidder from being distributed to the user terminal 40. Specifically, since advertising data is incorporated into the composite content generated by the auction apparatus 100, the composite content is not identical to the content created by the content creator. Therefore, for example, advertising data which damages the image of the content is likely to be incorporated into the composite content. In addition, since the advertiser participates in the auction in the planning stage, the advertiser buys the right to display advertisements at an auction, without checking the content created by the content creator. Therefore, advertising data is likely to be incorporated into the content which damages the image of the advertiser. In the example illustrated in FIG. 19, the auction apparatus 100 makes the content creator and the winning bidder confirm the composite content. Therefore, it is possible to prevent the distribution of the composite content which damages the image of the content creator or the winning bidder.

In the example illustrated in FIG. 19, the auction apparatus 100 may transmit the composite content only to one of the content creator and the winning bidder.

In the example illustrated in FIG. 19, the auction apparatus 100 may provide an editing site capable of incorporating advertising data into content to the content creator and the winning bidder. In addition, the editing site may generate composite content in response to the operation of the content creator or the winning bidder, and reproduce and edit the generated composite content. The editing site may display the content-plan stored in the auction storage unit 121. In this case, the advertiser can actually incorporate his or her advertising data into the content created by the content creator and check the entire impression of the composite content or the impression of the advertising data. Then, the advertiser can confirm the composite content and re-create advertising data corresponding to the content of a content item. As such, when the auction apparatus 100 provides the editing site, it is possible to improve the advertising effect of advertising data or the quality of composite content.

In the above-described embodiments, the plan receiving unit 131 may receive the plan information from the content creator a plurality of times. For example, when the actor of the moving image is changed due to a sudden illness, the plan receiving unit 131 may receive new plan information including information indicating that the actor has been changed. In this case, when the content-plan which is opened to the public is changed by the second or subsequent plan information received by the plan receiving unit 131, the auction providing unit 132 inquires the bidders or the winning bidder in the auction whether to invalidate the auction. When an instruction to invalidate the auction is received as a response from the bidder (for example, the highest bidder) or the winning bidder, the auction providing unit 132 invalidates the auction and holds an auction for the content of a new plan again. In this case, the auction providing unit 132 may invalidate all auctions related to the content or it may invalidate only the auction which is required to be invalidated by the bidder or the winning bidder.

### 2. Distribution of Use Fee

In the above-described embodiments, when the composite content is distributed as charged content to the user terminal 40, the use fee from the user of the user terminal 40 may be distributed to the content creator. That is, profits from the distribution of content by the distributor of the composite content may be shared by the content creator.

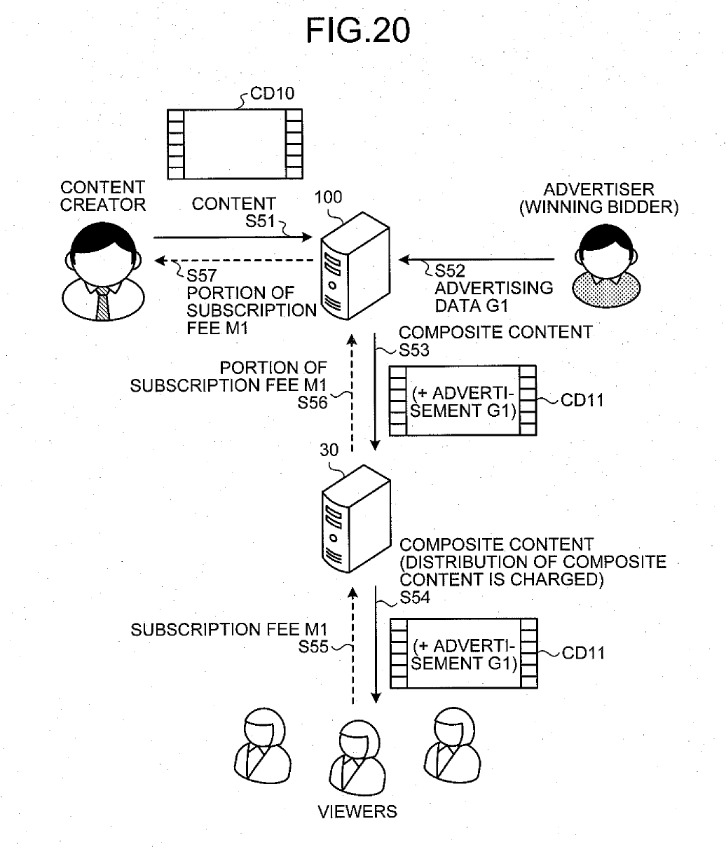

This will be described with reference to FIG. 20. FIG. 20 is a diagram illustrating an example of an auction process according to another embodiment. In the example illustrated in FIG. 20, the auction apparatus 100 receives content CD10 from the content creator (Step S51) and receives advertising data G1 from the advertiser (Step S52). Then, the auction apparatus 100 incorporates the advertising data G1 into the content CD10 to generate composite content CD11 and transmits the generated composite content CD11 to the distribution server 30 (Step S53).

The distribution server 30 distributes the composite content CD11 as charged content to the viewer (Step S54). Then, the distribution server 30 (or the operator of the distribution server 30) obtains a subscription fee M1 from the viewer whenever the composite content Coil is distributed (Step S55). In this case, the distribution server 30 transmits a portion of the subscription fee M1 to the auction apparatus 100 (Step S56). Then, the winning bid amount management unit 133 of the auction apparatus 100 sends a portion of the subscription fee M1 obtained from the distribution server 30 to the content creator (Step S57).

As such, the auction apparatus 100 sends a portion of the profits made from the distribution of the composite content as charged content. Therefore, it is possible to improve the creative will of the content creator. Specifically, as the popularity of the content created by the content creator increases, profits from the viewer increase and the fee distributed to the content creator increases. As a result, it is possible to improve the creative will of the content creator.

In the example illustrated in FIG. 20, the auction apparatus 100 may distribute a portion of the profits to the content creator only when a fee for the use of the composite content increases.

### 3. Distribution of Advertisement Rates

In the above-described embodiments, when a web page including composite content and advertisements is distributed to the user terminal 40, the advertisement rates obtained from the distribution of the advertisements may be distributed to the content creator. That is, advertising revenues from the distribution of the web page by the distributor of the composite content may be shared by the content creator.

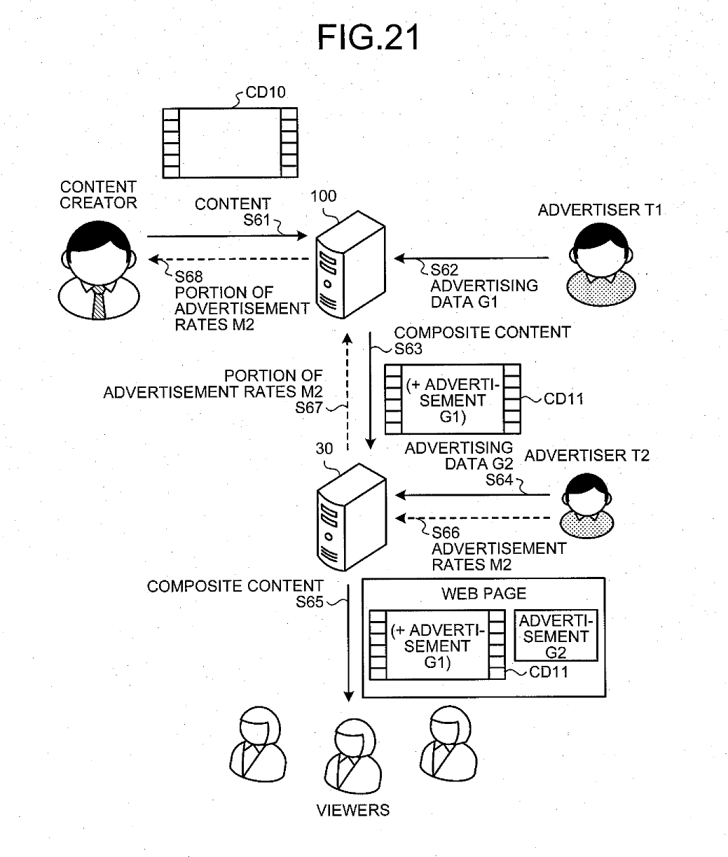

This will be described with reference to FIG. 21. FIG. 21 is a diagram illustrating an example of an auction process according to another embodiment. In the example illustrated in FIG. 21, it is assumed that an advertiser T1 has successfully bid for the right to display advertisements. The auction apparatus 100 receives content CD10 from the content creator (Step S61) and receives advertising data G1 from the advertiser T1 (Step S62). Then, the auction apparatus 100 transmits composite content CD11 to the distribution server 30 (Step S63).

The distribution server 30 receives advertising data G2 from an advertiser T2 (Step S64) and distributes a web page including the composite content CD11 and the advertising data G2 to the viewer (Step S65). Then, the distribution server 30 (or, for example, the operator of the distribution server 30) obtains advertisement rates M2 as a charge for the distribution of the advertising data G2 or a charge corresponding to the clicking of the advertising data G2 by the viewer from the advertiser T2 (Step S66). In this case, the distribution server 30 transmits a portion of the advertisement rates M2 to the auction apparatus 100 (Step S67). Then, the winning bid amount management unit 133 of the auction apparatus 100 sends a portion of the advertisement rates M2 obtained from the distribution server 30 to the content creator (Step S68).

As such, the auction apparatus 100 distributes a portion of the advertising revenues earned by the distributor who distributes the composite content and advertisements to the content creator. Therefore, it is possible to improve the creative will of the content creator. Specifically, as the popularity of the content created by the content creator increases, the advertising revenues earned from the advertiser T2 increase and the profits distributed to the content creator increase. As a result, it is possible to improve the creative will of the content creator. In the example illustrated in FIG. 21, the auction apparatus 100 sends a portion of the advertisement rates M2 to the content creator. However, the distribution server 30 may send a portion of the advertisement rates M2 to the content creator.

### 4. Right to Participate in Creation of Content

In the above-described embodiments, the auction providing unit 132 may provide the auction service in which the bid target is the right to display advertisements in the advertising space and the right to participate in the creation of content. Specifically, in general, the advertiser wants to incorporate advertising data into the content which is popular with the viewers or the content corresponding to his or her own image. Therefore, in some cases, when the advertiser has successfully bid the right to display advertisements, the advertiser wants to exchange opinions on the creation of content with the content creator. The auction providing unit 132 provides the auction service in which the bid target is the right to participate in the creation of content. Therefore, the advertiser who has successfully bid the right to participate in the creation of content can exchange opinions with the content creator such that content corresponding to his or her own image is generated. In addition, the content creator can reflect the opinions of the advertiser to the content to improve the value of the content. When the right to participate in the creation of content is sold at an auction, the bid price is expected to rise significantly. Therefore, the auction apparatus 100 can improve the possibility of the content creator raising desired funds.

The auction providing unit 132 may provide a platform for exchanging opinions between the content creator and the winning bidder. For example, the auction providing unit 132 may provide a telephone communication platform or a telephone conference platform through a dedicated line. In addition, the auction providing unit 132 may record the sound or image of conversational content and provide the recorded content to a dedicated site where the viewer can view the content. An evidence for confirming whether the content creator creates content according to the content-plan or an evidence for checking whether the advertiser makes an unreasonable demand for the content creator remains. That is, the auction apparatus 100 can provide the safe auction service to both the content creator and the advertiser. As a result, it is possible to improve the use of the auction service.

The content creator may arbitrarily select whether to set the right to participate in the creation of content to a bid target. In addition, the auction providing unit 132 may set the buyout price or the reserve price in the auction in which both the right to display advertisements in the advertising space and the right to participate in the creation of content are bid targets to be higher than that in the auction in which only the right to participate in the creation of content is a bid target.

### 5. Number of Input Advertising Data Items

In the above-described embodiments, the advertiser may transmit a plurality of advertising data items to the auction apparatus 100. In this case, the generating unit 135 of the auction apparatus 100 generates a plurality of composite content patterns corresponding to the number of advertising data items transmitted from the advertiser. For example, when the advertiser transmits advertising data items G11 and G12, the generating unit 135 generates composite content into which the advertising data G11 is incorporated and composite content into which the advertising data G12 is incorporated. Then, the transmitting unit 136 transmits the plurality of composite content patterns generated by the generating unit 135 to the distribution server 30. In this case, the distribution server 30 appropriately changes the composite content to be distributed among the plurality of composite content items. For example, the distribution server 30 distributes different composite content items to the user terminal 40 whenever the composite content is distributed a predetermined number of times.

In the above-mentioned example, the advertiser may transmit keywords for each advertising data to the auction apparatus 100. When a plurality of composite content patterns are generated, the generating unit 135 gives the keywords corresponding to the advertising data incorporated into the composite content to the corresponding composite content. In this case, the distribution server 30 can perform targeting distribution for the composite content using the keywords given to the composite content. For example, the distribution server 30 distributes the composite content to which keywords corresponding to the user attributes of the user, who is a distribution destination, are given. Therefore, the auction apparatus 100 can improve the advertising effect of the advertising data incorporated into the composite content.

### 6. Bid Aspects

In the above-described embodiments, the auction apparatus 100 may bid for the genre of content. Specifically, as in the example illustrated in FIG. 6, the auction providing unit 132 may bid for content genre “melodrama”, “school drama”, “sports”, and “documentary”, in addition to the advertising space. When the winning bidder for the genre of content is determined, the generating unit 135 incorporates the advertising data of the winning bidder into content corresponding to the genre to generate composite content.

### 7. Type of Content

In the above-described embodiments, the moving image is mainly given as an example of the content. However, the type of content is not limited to the moving image. Examples of the content may include applications, such as games, electronic books, and web pages, such as weblogs. For example, when the content creator plans to create games, electronic books, or professional web pages, the content creator can use the above-mentioned auction service.

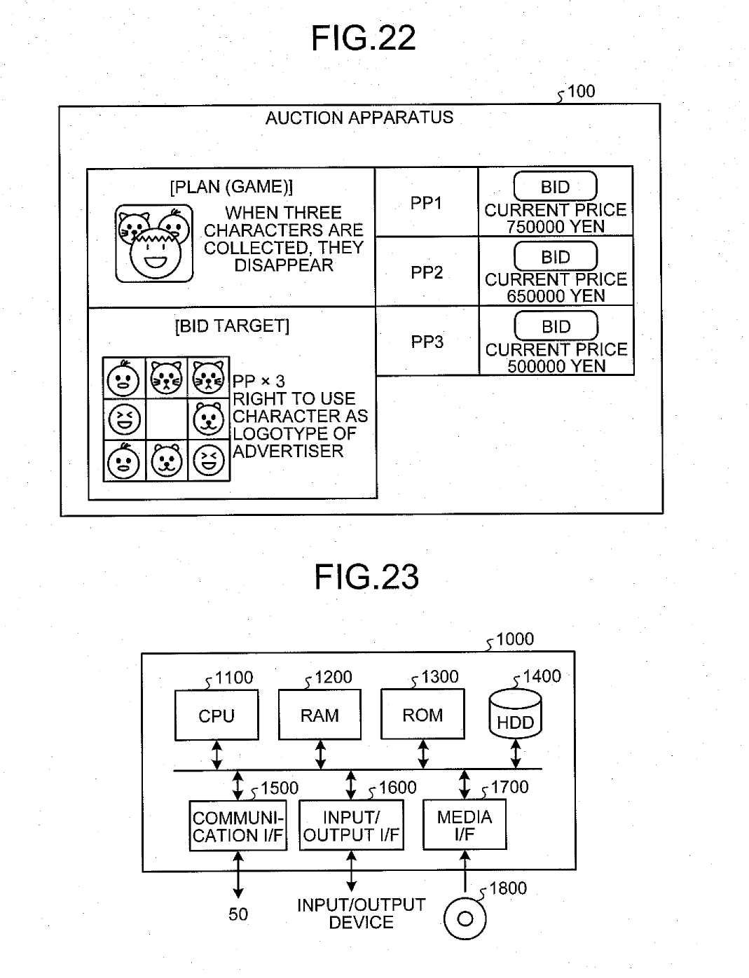

FIG. 22 illustrates an example of content according to another embodiment. FIG. 22 illustrates an example in which content is a game. In the example illustrated in FIG. 22, the content creator plans to create a game using character icons. The content creator sets three icons among plural types of icons as advertising spaces. As such, the above-mentioned auction service can also be applied to content, such as a game.

### 8. Program

The auction apparatuses 100 and 200 according to the above-described embodiments are implemented by, for example, a computer 1000 having the structure illustrated in FIG. 23. Next, the description will be made using the auction apparatus 100 as an example. FIG. 23 is a diagram illustrating an example of the hardware configuration of the computer 1000 which implements the functions of the auction apparatus 100. The computer 1000 includes a CPU 1100, a RAM 1200, a ROM 1300, an HDD 1400, a communication interface (I/F) 1500, an input/output interface (I/F) 1600, and a media interface (I/F) 1700.

The CPU 1100 operates on the basis of the programs stored in the ROM 1300 or the HDD 1400 and controls each unit. The ROM 1300 stores, for example, a boot program which is executed by the CPU 1100 when the computer 1000 starts up or programs depending on the hardware of the computer 1000.

The HDD 1400 stores, for example, the programs executed by the CPU 1100 and data used by the programs. The communication interface 1500 receives data from other apparatus through a communication network 50 and transmits the data to the CPU 1100. Alternatively, the communication interface 1500 transmits data generated by the CPU 1100 to other apparatuses through the communication network 50.

The CPU 1100 controls an output device, such as a display or a printer, and an input device, such as a keyboard or a mouse, through the input/output interface 1600. The CPU 1100 acquires data from the input device through the input/output interface 1600. In addition, the CPU 1100 outputs the generated data to the output device through the input/output interface 1600.

The media interface 1700 reads a program or data stored in a recording medium 1800 and provides the read program or data to the CPU 1100 through the RAM 1200. The CPU 1100 loads the program from the recording medium 1800 to the RAM 1200 through the media interface 1700 and executes the loaded program. Examples of the recording medium 1800 include an optical recording medium, such as a digital versatile disc (DVD) or a phase change rewritable disk (PD), a magneto-optical recording medium, such as a magneto-optical disk (MO), a tape medium, a magnetic recording medium, and a semiconductor memory.

For example, when the computer 1000 functions as the auction apparatus 100 according to the first embodiment, the CPU 1100 of the computer 1000 executes the program loaded onto the RAM 1200 to implement the functions of the control unit 130. The HDD 1400 stores the data of the auction storage unit 121. The CPU 1100 of the computer 1000 reads the programs from the recording medium 1800 and executes the program. However, as another example, the CPU 1100 may acquire the programs from other apparatuses through the communication network 50.

### 9. Others

Among the processes according to the above-described embodiments, some or all of the processes which are automatically performed may be manually performed, or some or all of the processes which are manually performed may be automatically performed by a known method. In addition, information including the procedure, the detailed names, and various kinds of data or parameters described in the above-mentioned document or drawings can be arbitrarily changed except in a case in which it is specified.

For example, various kinds of information illustrated in the drawings are limited to the illustrated information. For example, in the above-described embodiments, a plurality of advertising spaces are set to one content item. However, one advertising space may be set to one content item.

In the above-described embodiment, the content creator sets, for example, the reproduction position or reproduction time of the advertising space to the content. However, for example, the auction apparatus 100 may receive only the plan information from the content creator, but may not receive the advertising space information. In this case, the auction apparatus 100 may set, for example, a predetermined reproduction position or reproduction time of the advertising space in the content.

For example, in the above-described embodiments, the composite content obtained by incorporating advertising data into content is distributed to the user terminal 40. However, an advertisement server (for example, referred to as an ad server) which is not illustrated in FIG. 2 may distribute the advertising data to the user terminal 40 whenever the content creator is displayed on reproduced by the user terminal 40. Specifically, for example, the auction apparatus 100 may incorporate access information (for example, URL: Uniform Resource Locator) to the advertisement server into the advertising space of content to generate composite content. In this case, the user terminal 40 accesses the advertisement server on the basis of the access information set to the advertising space, acquires advertising data from the advertisement server, and displays the acquired advertising data in the advertising space. In this case, the advertiser may transmit, as the advertising data, access information for accessing a moving image or a still image, which is an advertisement, to the auction apparatus 100.

The drawings are conceptual diagrams illustrating the functions of each component of each apparatus, and the components are not necessarily physically configured as illustrated in the drawings. That is, the detailed form of the dispersion and integration of each apparatus is not limited to that illustrated in the drawings, but some or all of the apparatuses may be functionally and physically dispersed and integrated in an arbitrary unit, depending on various loads or usage conditions. For example, the plan receiving unit 131 and the content receiving unit 134 illustrated in FIG. 3 may be integrated with each other. In addition, for example, the auction apparatuses 100 and 200 may be integrated with the distribution server 30.

The above-described embodiments may be appropriately combined with each other in the range in which the content of the process is maintained consistently.

The embodiments of the invention have been described above with reference to the drawings. However, the embodiments are illustrative and various modifications and changes of the invention including the aspects described in the Detailed Description of the Embodiments can be made on the basis of knowledge of those skilled in the art.

In the claims, a “unit” can be replaced with a “section”, a “module”, or a “circuit”. For example, a plan receiving unit can be replaced with a plan receiving module or a plan receiving circuit.

According to an embodiment of the invention, it is possible to prevent the illegal use of the content-plan.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An auction apparatus comprising:
a communication unit configured to communicate with a communication network; and
a providing unit configured to present a portion of plan information indicating a plan of content which is created by a content creator through the communication network, configured to present the information which includes other plan information other than the portion of the plan information at least when a request is received from an advertiser who has browsed the portion of the plan information, and configured to provide an auction service in which a bid target is a right to display an advertisement in an advertising space set to the content.

2. The auction apparatus according to claim 1, further comprising:
a plan receiving unit configured to receive the plan information from the content creator,
wherein the providing unit presents a portion of the plan information received by the plan receiving unit and presents the other plan information when a request is received from the advertiser.

3. The auction apparatus according to claim 1, further comprising:
a plan receiving unit configured to receive first plan information corresponding to the portion of the plan information and second plan information corresponding to the other plan information from the content creator,
wherein the providing unit presents the first plan information received by the plan receiving unit and presents the second plan information when a request is received from an advertiser who has browsed the first plan information.

4. The auction apparatus according to claim 2,
wherein the plan receiving unit further receives advertising space information relating to the advertising space set to the content from the content creator, and
the providing unit provides the auction service on the basis of the advertising space information received by the plan receiving unit.

5. The auction apparatus according to claim 2,
wherein the plan receiving unit gradually receives the advertising space information, and
when the advertising space information is gradually received by the plan receiving unit and the date when an auction is held, which has not been set, is set, the providing unit notifies the advertiser who has browsed the plan information that the auction is held.

6. The auction apparatus according to claim 2,
wherein the providing unit presents a portion of the plan information to an advertiser selected by the content creator.

7. The auction apparatus according to claim 6,
wherein the providing unit transmits a list of advertisers who can participate in the auction service to the content creator and presents a portion of the plan information to the advertiser selected from the list of the advertisers by the content creator.

8. The auction apparatus according to claim 7,
wherein the providing unit transmits the list of the advertisers and the types of content desired by the advertisers to the content creator.

9. The auction apparatus according to claim 2,
wherein the plan receiving unit receives an item which can be presented as a portion of the plan information from the content creator, and
the providing unit presents the plan information corresponding to the item received by the plan receiving unit as the portion of the plan information.

10. The auction apparatus according to claim 2, further comprising:
a content receiving unit configured to receive content corresponding to the plan information from the content creator and configured to receive advertising data from an advertiser who has the right to display the advertisement in the auction service; and
a generating unit configured to generate composite content by incorporating the advertising data corresponding to the advertiser who has the right to display the advertisement in the advertising space into the advertising space which is set to the content when the content receiving unit receives the content and the advertising data.

11. The auction apparatus according to claim 10, further comprising:
a transmitting unit configured to transmit the composite content generated by the generating unit to at least one of the advertiser and the content creator before the composite content is distributed to a terminal apparatus of a user.

12. The auction apparatus according to claim 10, further comprising:
a verifying unit configured to verify consistency between the composite content generated by the generating unit and the plan of the content indicated by the plan information.

13. The auction apparatus according to claim 2,
wherein the providing unit notifies the type of business of a bidder who has bid for the bid target or a winning bidder who has successfully bid for the bid target in the auction service.

14. The auction apparatus according to claim 2,
wherein, when a plurality of advertising spaces are set to the content, the providing unit manages an auction related to each advertising space by associating with the plan information corresponding to the content.

15. The auction apparatus according to claim 2,
wherein, when a plurality of advertising spaces are set to the content, the providing unit provides the auction service in which the auction is held for a period which is set to each auction related to each advertising space.

16. The auction apparatus according to claim 15,
wherein the plan receiving unit receives advertising space information including the target amount of a winning bid price, and
the providing unit adjusts a reserve price or a buyout price in subsequent auctions on the basis of the winning bid price of the auction which has ended among the auctions corresponding to the plurality of advertising spaces and the target amount received by the plan receiving unit.

17. The auction apparatus according to claim 16,
wherein, when the total of the winning bid prices of each auction corresponding to the plurality of advertising spaces does not reach the target amount received by the plan receiving unit, the providing unit does not conclude each auction.

18. The auction apparatus according to claim 2,
wherein the providing unit provides the auction service in which bid targets are the right to display the advertisement in the advertising space and a right to participate in the creation of the content.

19. The auction apparatus according to claim 2, further comprising:
a winning bid amount management unit configured to manage a winning bid amount received from a winning bidder who has successfully bid for the right to display the advertisement in the auction service and sends a portion of or the entire winning bid amount to the content creator whenever the content creator charges the cost of creating the content.

20. The auction apparatus according to claim 19,
wherein the winning bid amount management unit sends the surplus of the winning bid amount to the content creator after the content creator creates the content.

21. An auction method that is performed by a computer, the auction method comprising:
communicating with a communication network; and
presenting a portion of plan information indicating a plan of content which is created by a content creator through the communication network, presenting the other plan information when a request is received from an advertiser who has browsed the portion of the plan information, and providing an auction service in which a bid target is a right to display an advertisement in an advertising space set to the content.

22. A non-transitory computer-readable storage medium with an executable program stored thereon, wherein the program instructs a computer to perform:
communicating with a communication network; and
presenting a portion of plan information indicating a plan of content which is created by a content creator through the communication network, presenting the other plan information when a request is received from an advertiser who has browsed the portion of the plan information, and providing an auction service in which a bid target is a right to display an advertisement in an advertising space set to the content.
